(19) United States
(12) Patent Application Publication
(10) Pub. No.: US 2023/0341004 A1
(43) Pub. Date: Oct. 26, 2023

(54) CLUTCH DEVICE

(71) Applicant: DENSO CORPORATION, Kariya-city (JP)

(72) Inventors: Takumi SUGIURA, Kariya-city (JP); Akira TAKAGI, Kariya-city (JP)

(21) Appl. No.: 18/327,515

(22) Filed: Jun. 1, 2023

Related U.S. Application Data
(63) Continuation of application No. PCT/JP2021/043892, filed on Nov. 30, 2021.

(30) Foreign Application Priority Data
Dec. 3, 2020 (JP) 2020-201318
Feb. 4, 2021 (JP) 2021-016911

(51) Int. Cl. F16H 3/66; F16H 57/021; F16C 19/54; F16D 13/52

(52) U.S. Cl. CPC F16D 13/52; F16C 19/546; F16H 3/666; F16H 57/021

(57) ABSTRACT

A prime mover includes a stator that is provided in a housing and a rotor that is provided rotatably relative to the stator, and is capable of outputting a torque from the rotor by being supplied with electric power. A bearing portion includes multiple bearing rolling bodies that roll in a circumferential direction of the rotor and rotatably support the rotor, and a lubricant that lubricates a periphery of the bearing rolling bodies. One bearing portion that rotatably supports the rotor is provided. A speed reducer includes an input unit that is provided rotatably integrally with and coaxially with the rotor and that receives the torque from the rotor.

### CROSS REFERENCE TO RELATED APPLICATION

The present application is a continuation application of International Patent Application No. PCT/JP2021/043892 filed on Nov. 30, 2021, which designated the U.S. and claims the benefit of priority from Japanese Patent Applications No. 2020-201318 filed on Dec. 3, 2020 and No. 2021-016911 filed on Feb. 4, 2021. The entire disclosures of all of the above applications are incorporated herein by reference.

### TECHNICAL FIELD

The present disclosure relates to a clutch device.

### BACKGROUND

Conventionally, a clutch device has been used to permit or block torque transmission.

### SUMMARY

A clutch device according to an aspect of the present disclosure comprises a housing, a prime mover, a speed reducer, a rotational translation unit, a clutch, and a state changing unit.

### BRIEF DESCRIPTION OF THE DRAWINGS

The above and other objects, features, and advantages of the present disclosure will become more apparent from the following detailed description with reference to the accompanying drawings. In the drawings:

FIG. 1 is a cross-sectional view showing a clutch device according to a first embodiment;

FIG. 2 is a cross-sectional view showing a part of the clutch device according to the first embodiment;

FIG. 3 is a schematic diagram of a 2kh-type strange planetary gear speed reducer, and a table showing a relationship among an input and output pattern, an inertia moment, and a speed reduction ratio;

FIG. 4 is a schematic diagram of a 3k-type strange planetary gear speed reducer, and a table showing a relationship among an input and output pattern, an inertia moment, and a speed reduction ratio;

FIG. 5 is a diagram showing a relationship between a stroke of a translation portion and a load acting on a clutch;

FIG. 6 is a cross-sectional view showing a bearing portion of the clutch device according to the first embodiment;

FIG. 7 is a diagram illustrating an effect of reducing the number of bearing rolling bodies of the bearing portion, in which an upper part is a diagram showing a bearing rolling body rolling in a holding hole portion, and a lower part is a diagram showing a state where the bearing rolling body is removed from the holding hole portion;

FIG. 8 is a diagram showing a relationship between an ambient temperature and a starting torque of the bearing portion;

FIG. 9 is a diagram showing a relationship between the number of bearing rolling bodies and the starting torque of the bearing portion or a load capacity of the bearing portion;

FIG. 10 is a diagram showing a return spring load, a ball cam load, and a rotor detent torque acting on or generated in the clutch device according to the first embodiment;

FIG. 11 is a diagram showing, for the return spring load, the ball cam load, and a clutch load, individual relationships between a stroke amount of the translation portion and magnitudes of the loads;

FIG. 12 is a diagram showing balance of torques acting on or generated in the clutch device according to the first embodiment;

FIG. 13 is a diagram showing an ACT load hysteresis characteristic which is a relationship between a motor torque and a load during a normal operation and a reverse operation of the clutch device according to the first embodiment;

FIG. 14 is a diagram showing rotation speeds when a prime mover according to the first embodiment and a prime mover according to a comparative embodiment are started;

FIG. 15 is a diagram showing relationships between the rotation speeds and rotation torques of the prime mover according to the first embodiment and the prime mover according to the comparative embodiment;

FIG. 16 is a schematic cross-sectional view showing a part of the clutch device according to the first embodiment;

FIG. 17 is a diagram illustrating a resultant force acting on an input unit of the speed reducer;

FIG. 18 is a diagram illustrating torque sharing rates of planetary gears of the speed reducer and the resultant force acting on the input unit of the speed reducer;

FIG. 19 is a cross-sectional view showing a clutch device according to a second embodiment;

FIG. 20 is a schematic cross-sectional view showing a part of a clutch device according to a third embodiment;

FIG. 21 is a schematic cross-sectional view showing a part of a clutch device according to a fourth embodiment;

FIG. 22 is a cross-sectional view showing a part of a clutch device according to a fifth embodiment; and

FIG. 23 is a cross-sectional view showing a part of a clutch device according to a sixth embodiment.

### DETAILED DESCRIPTION

Hereinafter, examples of the present disclosure will be described.

According to an example of the present disclosure, a clutch device is provided to permit or block torque transmission between a first transmission portion and a second transmission portion by changing a state of a clutch to an engaged state or a non-engaged state.

For example, a clutch device includes a prime mover, a speed reducer, a rotational translation unit, a clutch, and a state changing unit. The prime mover outputs a torque from a rotor by being supplied with electric power. The speed reducer decelerates and outputs the torque of the prime mover. Torque output from the speed reducer is input to the rotational translation unit. The state changing unit receives a force in an axial direction from the rotational translation unit and can change a state of the clutch to an engaged state or a non-engaged state.

In the clutch device, the speed reducer is a so-called eccentric cycloid speed reducer. Here, an input unit of the speed reducer is formed integrally with the rotor to be eccentric to a rotation shaft of the rotor of the prime mover. Therefore, a radial load is applied to the rotor in accordance with oscillating motion of the input unit. Accordingly, in order to ensure durability of a bearing of the rotor, a relatively large load capacity is required. According to an example, the clutch device includes two bearings including a first bearing that rotatably supports an end portion of the rotor on a side opposite to the input unit and a second bearing that rotatably supports an end portion of the rotor on an input unit side.

On the other hand, responsiveness of an actuator using an electric prime mover as a driving source, especially at a low temperature, greatly depends on a rotation torque of the bearing that supports the rotor. Therefore, it is considered that reducing the rotation torque of the bearing will lead to higher response at a low temperature. However, in a case where an eccentric speed reducer that requires a relatively large load capacity for the bearing is employed, when the number of rolling bodies of the bearing is reduced in order to reduce the rotation torque of the bearing, the durability may be reduced.

In a clutch device using an electric prime mover as a driving source, it may be required to quickly remove a load transmitted to a clutch, that is, to release the clutch when a power supply failure occurs due to a power line disconnection of the prime mover. In this case, a driven torque, which is a torque applied to the rotor from a clutch side, such as a reaction force from the clutch or a minimum load of a return spring, is necessary to be greater than a starting torque of the bearing and a cogging torque of the prime mover.

The starting torque of the bearing is proportional to a radial load, an axial load, a bending moment, and a magnetic force as a radial load generated between the rotor and a stator of the prime mover, and depends on a magnitude of a resistance for shearing a lubricant around the rolling bodies of the bearing when the rolling bodies roll. The latter increases in a low-temperature range where a kinematic viscosity of the lubricant increases. Therefore, when the power supply failure occurs at a low temperature, it may be difficult to remove the load transmitted to the clutch.

A clutch device according to an example of the present disclosure comprises a housing, a prime mover, a speed reducer, a rotational translation unit, a clutch, and a state changing unit. The prime mover includes a stator, which is provided in the housing and a rotor, which is configured to rotate relative to the stator, the prime mover configured to operate by energization and output a torque from the rotor. The speed reducer is configured to decelerate and output the torque of the prime mover.

The rotational translation unit includes a rotation portion that rotates relative to a housing when a torque output from a speed reducer is input and a translation portion that moves relative to the housing in an axial direction when the rotation portion rotates relative to the housing. The clutch is provided between a first transmission portion and a second transmission portion that are provided rotatably relative to the housing, and is configured to permit torque transmission between the first transmission portion and the second transmission portion when in an engaged state and to block the torque transmission between the first transmission portion and the second transmission portion when in a non-engaged state.

The state changing unit receives a force in the axial direction from the translation portion and can change a state of the clutch to the engaged state or the non-engaged state according to a relative position in the axial direction of the translation portion with respect to the housing. A bearing portion includes multiple bearing rolling bodies that roll in a circumferential direction of a rotor and rotatably support the rotor, and a lubricant that lubricates a periphery of the bearing rolling body. Here, only one bearing portion that rotatably supports the rotor is provided. The speed reducer includes an input unit that is provided rotatably integrally with and coaxially with the rotor and that receives the torque from the rotor.

In the present disclosure, when the torque is input from the prime mover to the input unit, the input unit rotates coaxially with the rotor. Therefore, a radial load acting on the input unit from a gear or the like provided in a radial direction of the input unit can be reduced. Therefore, the number of bearing portions rotatably supporting the rotor can be one.

Since the radial load acting on the input unit can be reduced, a decrease in durability can be reduced even if the number of bearing rolling bodies of the bearing portion is reduced. Therefore, the starting torque and rotation torque of the bearing portion can be reduced. Accordingly, the responsiveness, especially at a low temperature can be improved, and a minimum set load required to remove the load on the clutch when the power supply failure occurs can be reduced.

By reducing the number of bearing rolling bodies of the bearing portion, an inertia moment of the rotor can be reduced, and the responsiveness can be further improved.

Hereinafter, clutch devices according to multiple embodiments will be described with reference to the drawings. In the multiple embodiments, substantially the same components are denoted by the same reference numerals, and description thereof is omitted.

### First Embodiment

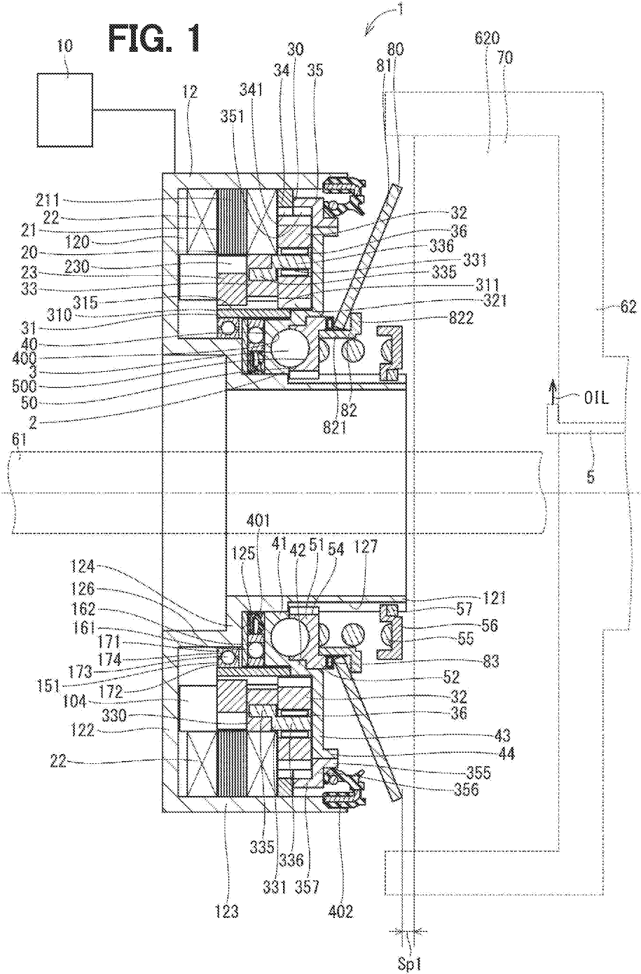

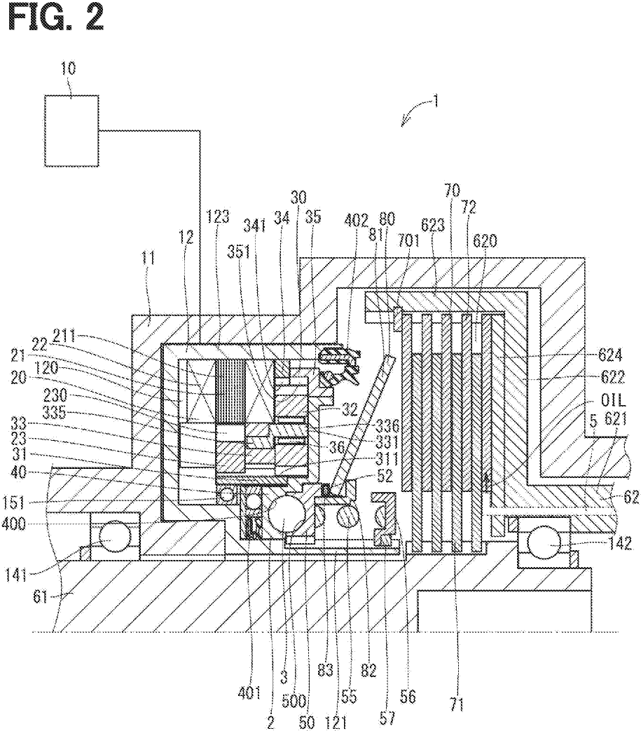

FIGS. 1 and 2 show a clutch device according to a first embodiment. A clutch device 1 is provided, for example, between an internal combustion engine and a transmission of a vehicle, and is used to permit or block torque transmission between the internal combustion engine and the transmission.

The clutch device 1 includes a housing 12, a motor 20 as a “prime mover”, a speed reducer 30, a ball cam 2 as a “rotational translation unit” or a “rolling body cam”, a clutch 70, a state changing unit 80, and a bearing portion 151.

The clutch device 1 further includes an electronic control unit (hereinafter referred to as “ECU”) 10 as a “control unit”, an input shaft 61 as a “first transmission portion”, and an output shaft 62 as a “second transmission portion”.

The ECU 10 is a small computer including a CPU as a calculation means, a ROM, a RAM, and the like as a storage means, an I/O as an input and output means, and the like. The ECU 10 executes calculation according to a program stored in the ROM or the like based on information such as signals from various sensors provided in each part of the vehicle, and controls operations of various devices and machines of the vehicle. In this way, the ECU 10 executes a program stored in a non-transitory tangible storage medium. By executing the program, a method corresponding to the program is executed.

The ECU 10 can control an operation of the internal combustion engine and the like based on the information such as the signals from various sensors. The ECU 10 can also control an operation of the motor 20 to be described later.

The input shaft 61 is connected to, for example, a drive shaft (not shown) of the internal combustion engine, and is rotatable together with the drive shaft. That is, a torque is input to the input shaft 61 from the drive shaft.

The vehicle equipped with the internal combustion engine is provided with a fixed body 11 (see FIG. 2). The fixed body 11 is formed, for example, in a tubular shape, and is fixed to an engine compartment of the vehicle. A ball bearing 141 is provided between an inner peripheral wall of the fixed body 11 and an outer peripheral wall of the input shaft 61. Accordingly, the input shaft 61 is bearing-supported by the fixed body 11 via the ball bearing 141.

The housing 12 is provided between the inner peripheral wall of the fixed body 11 and the outer peripheral wall of the input shaft 61. The housing 12 includes a housing inner cylinder portion 121, a housing plate portion 122, a housing outer cylinder portion 123, a housing small plate portion 124, a housing step surface 125, a housing small inner cylinder portion 126, a housing-side spline groove portion 127, and the like.

The housing inner cylinder portion 121 is formed in a substantially cylindrical shape. The housing small plate portion 124 is formed in an annular plate shape to extend to a radially outer side from an end portion of the housing inner cylinder portion 121. The housing small inner cylinder portion 126 is formed in a substantially cylindrical shape to extend from an outer edge portion of the housing small plate portion 124 to a side opposite to the housing inner cylinder portion 121. The housing plate portion 122 is formed in an annular plate shape to extend to the radially outer side from an end portion of the housing small inner cylinder portion 126 on a side opposite to the housing small plate portion 124. The housing outer cylinder portion 123 is formed in a substantially cylindrical shape to extend from an outer edge portion of the housing plate portion 122 to the same side as the housing small inner cylinder portion 126 and the housing inner cylinder portion 121. Here, the housing inner cylinder portion 121, the housing small plate portion 124, the housing small inner cylinder portion 126, the housing plate portion 122, and the housing outer cylinder portion 123 are integrally formed of, for example, metal.

As described above, the housing 12 is formed in a hollow and flat shape as a whole.

The housing step surface 125 is formed in an annular planar shape on a surface of the housing small plate portion 124 on a side opposite to the housing small inner cylinder portion 126. The housing-side spline groove portion 127 is formed in an outer peripheral wall of the housing inner cylinder portion 121 to extend in an axial direction of the housing inner cylinder portion 121. Multiple housing-side spline groove portions 127 are formed in a circumferential direction of the housing inner cylinder portion 121.

The housing 12 is fixed to the fixed body 11 such that a part of an outer wall is in contact with a part of a wall surface of the fixed body 11 (see FIG. 2). The housing 12 is fixed to the fixed body 11 by bolts (not shown) or the like. Here, the housing 12 is provided coaxially with the fixed body 11 and the input shaft 61. In addition, a substantially cylindrical space is formed between an inner peripheral wall of the housing inner cylinder portion 121 and the outer peripheral wall of the input shaft 61.

The housing 12 has an accommodation space 120. The accommodation space 120 is defined by the housing inner cylinder portion 121, the housing small plate portion 124, the housing small inner cylinder portion 126, the housing plate portion 122, and the housing outer cylinder portion 123.

The motor 20 is accommodated in the accommodation space 120. The motor 20 includes a stator 21, a rotor 23, and the like. The stator 21 includes a stator core 211 and a coil 22. The stator core 211 is formed of, for example, a laminated steel plate in a substantially annular shape, and is fixed to an inside of the housing outer cylinder portion 123. The coil 22 is provided on each of multiple salient poles of the stator core 211.

The motor 20 includes a magnet 230 as a “permanent magnet”. The rotor 23 is formed of, for example, iron-based metal in a substantially annular shape. More specifically, the rotor 23 is formed of, for example, pure iron having a relatively high magnetic property.

The magnet 230 is provided on an outer peripheral wall of the rotor 23. Multiple magnets 230 are provided at equal intervals in a circumferential direction of the rotor 23 such that magnetic poles are alternately arranged.

The bearing portion 151 is provided on an outer peripheral wall of the housing small inner cylinder portion 126. A sun gear 31, which will be described later, is provided on the radially outer side of the bearing portion 151. The rotor 23 is provided on the radially outer side of the sun gear 31 so as not to be rotatable relative to the sun gear 31. The bearing portion 151 is provided in the accommodation space 120 and rotatably supports the sun gear 31, the rotor 23, and the magnets 230.

Here, the rotor 23 is provided on a radially inner side of the stator core 211 of the stator 21 to be rotatable relative to the stator 21. The motor 20 is an inner rotor-type brushless DC motor.

Configurations and the like of the bearing portion 151 will be described in detail later.

The ECU 10 can control the operation of the motor 20 by controlling electric power supplied to the coil 22. When the electric power is supplied to the coil 22, a rotating magnetic field is generated in the stator core 211, and the rotor 23 rotates. Accordingly, the torque is output from the rotor 23. In this way, the motor 20 includes the stator 21 and the rotor 23 provided rotatably relative to the stator 21, and can output the torque from the rotor 23 by being supplied with electric power.

In the present embodiment, the clutch device 1 includes a rotation angle sensor 104. The rotation angle sensor 104 is provided in the accommodation space 120.

The rotation angle sensor 104 detects a magnetic flux generated from a sensor magnet rotating integrally with the rotor 23, and outputs a signal corresponding to the detected magnetic flux to the ECU 10. Accordingly, the ECU 10 can detect a rotation angle, a rotation speed, and the like of the rotor 23 based on the signal from the rotation angle sensor 104. In addition, the ECU 10 can calculate, based on the rotation angle, the rotation speed, and the like of the rotor 23, a relative rotation angle of a drive cam 40 with respect to the housing 12 and a driven cam 50 to be described later, relative positions of the driven cam 50 and the state changing unit 80 in the axial direction with respect to the housing 12 and the drive cam 40, and the like.

The speed reducer 30 is accommodated in the accommodation space 120. The speed reducer 30 includes the sun gear 31, a planetary gear 32, a carrier 33, a first ring gear 34, a second ring gear 35, and the like.

The sun gear 31 is provided coaxially with and integrally rotatably with the rotor 23. That is, the rotor 23 and the sun gear 31 are formed separately, and are coaxially arranged to be integrally rotatable.

More specifically, the sun gear 31 includes a sun gear main body 310, a sun gear tooth portion 311 as a “tooth portion” and “external tooth”, and a gear-side groove portion 315. The sun gear main body 310 is formed of, for example, metal in a substantially cylindrical shape. The gear-side groove portion 315 is formed to extend in the axial direction on an outer peripheral wall of the sun gear main body 310 on one end portion side. Multiple gear-side groove portions 315 are formed in a circumferential direction of the sun gear main body 310. The one end portion side of the sun gear main body 310 is bearing-supported by the bearing portion 151.

Groove portions corresponding to the gear-side groove portions 315 are formed in an inner peripheral wall of the rotor 23. The rotor 23 is located on the radially outer side of one end portion of the sun gear 31, and the groove portions are provided to be coupled to the gear-side groove portions 315. Accordingly, the rotor 23 is not rotatable relative to the sun gear 31.

The sun gear tooth portion 311 is formed on an outer peripheral wall of the sun gear 31 on the other end portion side. The torque of the motor 20 is input to the sun gear 31 that rotates integrally with the rotor 23. Here, the sun gear tooth portion 311 of the sun gear 31 corresponds to the “input unit” of the speed reducer 30. In the present embodiment, the sun gear 31 is formed of, for example, a steel material.

Multiple planetary gears 32 are provided in a circumferential direction of the sun gear 31, and can revolve in the circumferential direction of the sun gear 31 while meshing with the sun gear 31 and rotating on its axis. More specifically, the planetary gears 32 each are formed of, for example, metal in a substantially cylindrical shape, and four planetary gears 32 are provided at equal intervals in the circumferential direction of the sun gear 31 on the radially outer side of the sun gear 31. The planetary gear 32 includes a planetary gear tooth portion 321 as a “tooth portion” and “external teeth”. The planetary gear tooth portion 321 is formed on an outer peripheral wall of the planetary gear 32 to mesh with the sun gear tooth portion 311.

The carrier 33 rotatably supports the planetary gears 32 and is rotatable relative to the sun gear 31. More specifically, the carrier 33 is provided on the radially outer side of the sun gear 31. The carrier 33 is rotatable relative to the rotor 23 and the sun gear 31.

The carrier 33 includes a carrier main body 330 and a pin 331. The carrier main body 330 is formed of, for example, metal in a substantially annular shape. The carrier main body 330 is located between the sun gear 31 and the coil 22 in the radial direction, and is located between the rotor 23 and the magnet 230 and the planetary gear 32 in the axial direction. The planetary gear 32 is located on a side opposite to the housing plate portion 122 with respect to the carrier main body 330 and the coil 22.

The pin 331 includes a connection portion 335 and a support portion 336. The connection portion 335 and the support portion 336 are each formed of, for example, metal in a columnar shape. The connection portion 335 and the support portion 336 are integrally formed such that their respective axes are shifted from each other and are parallel to each other. Therefore, the connection portion 335 and the support portion 336 have a crank-like cross-sectional shape along a virtual plane including their respective axes (see FIG. 1).

The pin 331 is fixed to the carrier main body 330 such that the connection portion 335, which is a portion on one end portion side, is connected to the carrier main body 330. Here, the support portion 336 is provided such that the axis of the support portion 336 is located on the radially outer side of the carrier main body 330 with respect to the axis of the connection portion 335 on a side of the carrier main body 330 opposite to the rotor 23 and the magnet 230 (see FIG. 1). A total of four pins 331 are provided corresponding to the number of planetary gears 32.

The speed reducer 30 includes a planetary gear bearing 36. The planetary gear bearing 36 is, for example, a needle bearing, and is provided between an outer peripheral wall of the support portion 336 of the pin 331 and an inner peripheral wall of the planetary gear 32. Accordingly, the planetary gear 32 is rotatably supported by the support portion 336 of the pin 331 via the planetary gear bearing 36.

The first ring gear 34 includes a first ring gear tooth portion 341 that is a tooth portion that can mesh with the planetary gear 32, and is fixed to the housing 12. More specifically, the first ring gear 34 is formed of, for example, metal in a substantially annular shape. The first ring gear 34 is fixed to the housing 12 such that an outer edge portion is fitted to an inner peripheral wall of the housing outer cylinder portion 123 on a side opposite to the housing plate portion 122 with respect to the coil 22. Therefore, the first ring gear 34 is not rotatable relative to the housing 12.

Here, the first ring gear 34 is provided coaxially with the housing 12, the rotor 23, and the sun gear 31. The first ring gear tooth portion 341 as a “tooth portion” and “internal teeth” is formed in an inner edge portion of the first ring gear 34 to be able to mesh with one end portion side in the axial direction of the planetary gear tooth portion 321 of the planetary gear 32.

The second ring gear 35 includes a second ring gear tooth portion 351 that is a tooth portion that can mesh with the planetary gear 32 and has a different number of teeth from the first ring gear tooth portion 341, and is provided rotatably integrally with the drive cam 40 to be described later. More specifically, the second ring gear 35 is formed of, for example, metal in a substantially annular shape. The second ring gear 35 includes a gear inner cylinder portion 355, a gear plate portion 356, and a gear outer cylinder portion 357. The gear inner cylinder portion 355 is formed in a substantially cylindrical shape. The gear plate portion 356 is formed in an annular plate shape to extend to the radially outer side from one end of the gear inner cylinder portion 355. The gear outer cylinder portion 357 is formed in a substantially cylindrical shape to extend from an outer edge portion of the gear plate portion 356 to a side opposite to the gear inner cylinder portion 355.

Here, the second ring gear 35 is provided coaxially with the housing 12, the rotor 23, and the sun gear 31. The second ring gear tooth portion 351 as a “tooth portion” and “internal teeth” is formed on an inner peripheral wall of the gear outer cylinder portion 357 to be able to mesh with the other end portion side in the axial direction of the planetary gear tooth portion 321 of the planetary gear 32. In the present embodiment, the number of teeth of the second ring gear tooth portion 351 is larger than the number of teeth of the first ring gear tooth portion 341. More specifically, the number of teeth of the second ring gear tooth portion 351 is larger than the number of teeth of the first ring gear tooth portion 341 by a number obtained by multiplying 4, which is the number of planetary gears 32, by an integer.

Since the planetary gear 32 is required to normally mesh with the first ring gear 34 and the second ring gear 35 having two different specifications at the same portion without interference, the planetary gear 32 is designed such that one or both of the first ring gear 34 and the second ring gear 35 are dislocated to keep a center distance of each gear pair constant.

With the above configuration, when the rotor 23 of the motor 20 rotates, the sun gear 31 rotates, and the planetary gear tooth portion 321 of the planetary gear 32 revolves in the circumferential direction of the sun gear 31 while meshing with the sun gear tooth portion 311, the first ring gear tooth portion 341, and the second ring gear tooth portion 351 and rotating on its axis. Here, since the number of teeth of the second ring gear tooth portion 351 is larger than the number of teeth of the first ring gear tooth portion 341, the second ring gear 35 rotates relative to the first ring gear 34. Therefore, between the first ring gear 34 and the second ring gear 35, a minute differential rotation corresponding to a difference in the number of teeth between the first ring gear tooth portion 341 and the second ring gear tooth portion 351 is output as a rotation of the second ring gear 35. Accordingly, the torque from the motor 20 is decelerated by the speed reducer 30 and output from the second ring gear 35. In this way, the speed reducer 30 can decelerate and output the torque of the motor 20. In the present embodiment, the speed reducer 30 constitutes a 3k-type strange planetary gear speed reducer.

The second ring gear 35 is formed separately from the drive cam 40 to be described later, and is provided rotatably integrally with the drive cam 40. The second ring gear 35 decelerates the torque from the motor 20 and outputs the torque to the drive cam 40. Here, the second ring gear 35 corresponds to an “output unit” of the speed reducer 30.

The ball cam 2 includes the drive cam 40 as a “rotation portion”, the driven cam 50 as a “translation portion”, and balls 3 as a “rolling body”.

The drive cam 40 includes a drive cam main body 41, a drive cam inner cylinder portion 42, a drive cam plate portion 43, a drive cam outer cylinder portion 44, a drive cam groove 400, and the like. The drive cam main body 41 is formed in a substantially annular plate shape. The drive cam inner cylinder portion 42 is formed in a substantially cylindrical shape to extend in the axial direction from an outer edge portion of the drive cam main body 41. The drive cam plate portion 43 is formed in a substantially annular plate shape to extend to the radially outer side from an end portion of the drive cam inner cylinder portion 42 on a side opposite to the drive cam main body 41. The drive cam outer cylinder portion 44 is formed in a substantially cylindrical shape to extend from an outer edge portion of the drive cam plate portion 43 to a side opposite to the drive cam inner cylinder portion 42. Here, the drive cam main body 41, the drive cam inner cylinder portion 42, the drive cam plate portion 43, and the drive cam outer cylinder portion 44 are integrally formed of, for example, metal.

The drive cam groove 400 is formed to extend in the circumferential direction while being recessed from a surface of the drive cam main body 41 on a drive cam inner cylinder portion 42 side. For example, five drive cam grooves 400 are formed at equal intervals in a circumferential direction of the drive cam main body 41. The drive cam groove 400 is formed with a groove bottom inclined with respect to the surface of the drive cam main body 41 on the drive cam inner cylinder portion 42 side such that a depth becomes shallower from one end to the other end in the circumferential direction of the drive cam main body 41.

The drive cam 40 is provided between the housing inner cylinder portion 121 and the housing outer cylinder portion 123 such that the drive cam main body 41 is located between the outer peripheral wall of the housing inner cylinder portion 121 and an inner peripheral wall of the sun gear 31, and the drive cam plate portion 43 is located on a side opposite to the carrier main body 330 with respect to the planetary gear 32. The drive cam 40 is rotatable relative to the housing 12.

The second ring gear 35 is provided integrally with the drive cam 40 such that an inner peripheral wall of the gear inner cylinder portion 355 is fitted to an outer peripheral wall of the drive cam outer cylinder portion 44. The second ring gear 35 is not rotatable relative to the drive cam 40. That is, the second ring gear 35 is provided rotatably integrally with the drive cam 40 as a “rotation portion”. Therefore, when the torque from the motor 20 is decelerated by the speed reducer 30 and output from the second ring gear 35, the drive cam 40 rotates relative to the housing 12. That is, when the torque output from the speed reducer 30 is input to the drive cam 40, the drive cam 40 rotates relative to the housing 12.

The driven cam 50 includes a driven cam main body 51, a driven cam cylinder portion 52, a cam-side spline groove portion 54, a driven cam groove 500, and the like. The driven cam main body 51 is formed in a substantially annular plate shape. The driven cam cylinder portion 52 is formed in a substantially cylindrical shape to extend in the axial direction from an outer edge portion of the driven cam main body 51. Here, the driven cam main body 51 and the driven cam cylinder portion 52 are integrally formed of, for example, metal.

The cam-side spline groove portion 54 is formed to extend in the axial direction in an inner peripheral wall of the driven cam main body 51. Multiple cam-side spline groove portions 54 are formed in a circumferential direction of the driven cam main body 51.

The driven cam 50 is provided such that the driven cam main body 51 is located on a side opposite to the housing step surface 125 with respect to the drive cam main body 41 and the radially inner side of the drive cam inner cylinder portion 42 and the drive cam plate portion 43, and the cam-side spline groove portions 54 are spline-coupled to the housing-side spline groove portions 127. Accordingly, the driven cam 50 is not rotatable relative to the housing 12 and is movable relative to the housing 12 in the axial direction.

The driven cam groove 500 is formed to extend in the circumferential direction while being recessed from a surface of the driven cam main body 51 on a drive cam main body 41 side. For example, five driven cam grooves 500 are formed at equal intervals in the circumferential direction of the driven cam main body 51. The driven cam groove 500 is formed with a groove bottom inclined with respect to the surface of the driven cam main body 51 on the drive cam main body 41 side such that a depth becomes shallower from one end to the other end in the circumferential direction of the driven cam main body 51.

The drive cam groove 400 and the driven cam groove 500 are each formed to have the same shape when viewed from a surface side of the drive cam main body 41 on a driven cam main body 51 side or from a surface side of the driven cam main body 51 on the drive cam main body 41 side.

The balls 3 are formed of, for example, metal in a spherical shape. The balls 3 are provided to be able to roll between five drive cam grooves 400 and five driven cam grooves 500, respectively. That is, five balls 3 are provided in total.

In this way, the drive cam 40, the driven cam 50, and the balls 3 constitute the ball cam 2 as a “rolling body cam”. When the drive cam 40 rotates relative to the housing 12 and the driven cam 50, the balls 3 roll along the respective groove bottoms in the drive cam grooves 400 and the driven cam grooves 500.

As shown in FIG. 1, the balls 3 are provided on the radially inner side of the first ring gear 34 and the second ring gear 35. More specifically, most of the balls 3 are provided within a range in the axial direction of the first ring gear 34 and the second ring gear 35.

As described above, the drive cam groove 400 is formed such that the groove bottom is inclined from the one end to the other end. In addition, the driven cam groove 500 is formed such that the groove bottom is inclined from the one end to the other end. Therefore, when the drive cam 40 rotates relative to the housing 12 and the driven cam 50 due to the torque output from the speed reducer 30, the balls 3 roll in the drive cam grooves 400 and the driven cam grooves 500, and the driven cam 50 moves relative to the drive cam 40 and the housing 12 in the axial direction, that is, strokes.

In this way, when the drive cam 40 rotates relative to the housing 12, the driven cam 50 moves relative to the drive cam 40 and the housing 12 in the axial direction. Here, since the cam-side spline groove portions 54 are spline-coupled to the housing-side spline groove portions 127, the driven cam 50 does not rotate relative to the housing 12. In addition, the drive cam 40 rotates relative to the housing 12, but does not move relative to the housing 12 in the axial direction.

In the present embodiment, the clutch device 1 includes a return spring 55, a return spring retainer 56, and a C ring 57. The return spring 55 is, for example, a coil spring, and is provided on the radially outer side of an end portion of the housing inner cylinder portion 121 on a side opposite to the housing small plate portion 124 on a side of the driven cam main body 51 opposite to the drive cam main body 41. One end of the return spring 55 is in contact with a surface of the driven cam main body 51 on a side opposite to the drive cam main body 41.

The return spring retainer 56 is formed of, for example, metal in a substantially annular shape, and is in contact with the other end of the return spring 55 on the radially outer side of the housing inner cylinder portion 121. The C ring 57 is fixed to the outer peripheral wall of the housing inner cylinder portion 121 to lock a surface of the inner edge portion of the return spring retainer 56 on a side opposite to the driven cam main body 51.

The return spring 55 has a force extending in the axial direction. Therefore, the driven cam 50 is urged to the drive cam main body 41 side by the return spring 55 in a state where the ball 3 is sandwiched between the driven cam 50 and the drive cam 40.

The output shaft 62 includes a shaft portion 621, a plate portion 622, a cylinder portion 623, and a friction plate 624 (see FIG. 2). The shaft portion 621 is formed in a substantially cylindrical shape. The plate portion 622 is formed integrally with the shaft portion 621 to extend in an annular plate shape from one end of the shaft portion 621 to the radially outer side. The cylinder portion 623 is formed integrally with the plate portion 622 to extend in a substantially cylindrical shape from an outer edge portion of the plate portion 622 to a side opposite to the shaft portion 621. The friction plate 624 is formed in a substantially annular plate shape, and is provided on an end surface of the plate portion 622 on a cylinder portion 623 side. Here, the friction plate 624 is not rotatable relative to the plate portion 622. A clutch space 620 is formed in an inside of the cylinder portion 623.

An end portion of the input shaft 61 passes through an inside of the housing inner cylinder portion 121 and is located on a side opposite to the drive cam 40 with respect to the driven cam 50. The output shaft 62 is provided coaxially with the input shaft 61 on the side opposite to the drive cam 40 with respect to the driven cam 50. A ball bearing 142 is provided between an inner peripheral wall of the shaft portion 621 and an outer peripheral wall of the end portion of the input shaft 61. Accordingly, the output shaft 62 is bearing-supported by the input shaft 61 via the ball bearing 142. The input shaft 61 and the output shaft 62 are rotatable relative to the housing 12.

The clutch 70 is provided between the input shaft 61 and the output shaft 62 in the clutch space 620. The clutch 70 includes inner friction plates 71, outer friction plates 72, and a locking portion 701. Multiple inner friction plates 71 are each formed in a substantially annular plate shape, and are aligned in the axial direction between the input shaft 61 and the cylinder portion 623 of the output shaft 62. The inner friction plate 71 is provided such that an inner edge portion is spline-coupled to the outer peripheral wall of the input shaft 61. Therefore, the inner friction plates 71 are not rotatable relative to the input shaft 61 and are movable relative to the input shaft 61 in the axial direction.

Multiple outer friction plates 72 are each formed in a substantially annular plate shape, and are aligned in the axial direction between the input shaft 61 and the cylinder portion 623 of the output shaft 62. Here, the inner friction plates 71 and the outer friction plates 72 are alternately arranged in the axial direction of the input shaft 61. An outer edge portion of the outer friction plate 72 is spline-coupled to an inner peripheral wall of the cylinder portion 623 of the output shaft 62. Therefore, the outer friction plate 72 is not rotatable relative to the output shaft 62 and is movable relative to the output shaft 62 in the axial direction. Among the multiple outer friction plates 72, the outer friction plate 72 located closest to a friction plate 624 side can come into contact with the friction plate 624.

The locking portion 701 is formed in a substantially annular shape, and is provided such that an outer edge portion is fitted to the inner peripheral wall of the cylinder portion 623 of the output shaft 62. The locking portion 701 can lock an outer edge portion of the outer friction plate 72 located closest to the driven cam 50 among the multiple outer friction plates 72. Therefore, the multiple outer friction plates 72 and the multiple inner friction plates 71 are restricted from coming off from the inside of the cylinder portion 623. A distance between the locking portion 701 and the friction plate 624 is larger than a sum of plate thicknesses of the multiple outer friction plates 72 and the multiple inner friction plates 71.

In an engaged state in which the multiple inner friction plates 71 and the multiple outer friction plates 72 come into contact with each other, that is, are engaged with each other, a frictional force is generated between the inner friction plates 71 and the outer friction plates 72, and relative rotation between the inner friction plates 71 and the outer friction plates 72 is restricted according to a magnitude of the frictional force. On the other hand, in a non-engaged state in which the multiple inner friction plates 71 and the multiple outer friction plates 72 are separated from each other, that is, are not engaged with each other, no frictional force is generated between the inner friction plates 71 and the outer friction plates 72, and the relative rotation between the inner friction plates 71 and the outer friction plates 72 is not restricted.

When the clutch 70 is in the engaged state, the torque input to the input shaft 61 is transmitted to the output shaft 62 via the clutch 70. On the other hand, when the clutch 70 is in the non-engaged state, the torque input to the input shaft 61 is not transmitted to the output shaft 62.

In this way, the clutch 70 transmits the torque between the input shaft 61 and the output shaft 62. The clutch 70 permits torque transmission between the input shaft 61 and the output shaft 62 during the engaged state in which the clutch 70 is engaged, and blocks the torque transmission between the input shaft 61 and the output shaft 62 during the non-engaged state in which the clutch 70 is not engaged.

In the present embodiment, the clutch device 1 is a so-called normally open type clutch device that is normally in the non-engaged state.

The state changing unit 80 includes a disk spring 81 serving as an “elastic deformation portion”, a disk spring retainer 82, and a thrust bearing 83. The disk spring retainer 82 includes a retainer cylinder portion 821 and a retainer flange portion 822. The retainer cylinder portion 821 is formed in a substantially cylindrical shape. The retainer flange portion 822 is formed in an annular plate shape to extend from one end of the retainer cylinder portion 821 to the radially outer side. The retainer cylinder portion 821 and the retainer flange portion 822 are integrally formed of, for example, metal. The disk spring retainer 82 is fixed to the driven cam 50 such that an outer peripheral wall of the other end of the retainer cylinder portion 821 is fitted to an inner peripheral wall of the driven cam cylinder portion 52.

The disk spring 81 is provided such that an inner edge portion is located between the driven cam cylinder portion 52 and the retainer flange portion 822 on the radially outer side of the retainer cylinder portion 821. The thrust bearing 83 is provided between the driven cam cylinder portion 52 and the disk spring 81.

The disk spring retainer 82 is fixed to the driven cam 50 such that the retainer flange portion 822 can lock one end of the disk spring 81 in the axial direction, that is, the inner edge portion. Therefore, the disk spring 81 and the thrust bearing 83 are restricted from coming off from the disk spring retainer 82 by the retainer flange portion 822. The disk spring 81 is elastically deformable in the axial direction.

When the ball 3 is located at one end of the drive cam groove 400 and the driven cam groove 500, a distance between the drive cam 40 and the driven cam 50 is relatively small, and a gap Sp1 is formed between the clutch 70 and the other end of the disk spring 81 in the axial direction, that is, an outer edge portion (see FIG. 1). Therefore, the clutch 70 is in the non-engaged state, and the torque transmission between the input shaft 61 and the output shaft 62 is blocked.

Here, when the electric power is supplied to the coil 22 of the motor 20 under the control of the ECU 10, the motor 20 rotates, the torque is output from the speed reducer 30, and the drive cam 40 rotates relative to the housing 12. Accordingly, the ball 3 rolls from the one end to the other end of the drive cam groove 400 and the driven cam groove 500. Therefore, the driven cam 50 moves relative to the housing 12 in the axial direction, that is, moves toward the clutch 70 while compressing the return spring 55. Accordingly, the disk spring 81 moves toward the clutch 70.

When the disk spring 81 moves toward the clutch 70 due to the movement of the driven cam 50 in the axial direction, the gap Sp1 decreases, and the other end of the disk spring 81 in the axial direction comes into contact with the outer friction plate 72 of the clutch 70. When the driven cam 50 further moves in the axial direction after the disk spring 81 comes into contact with the clutch 70, the disk spring 81 pushes the outer friction plate 72 toward the friction plate 624 while elastically deforming in the axial direction. Accordingly, the multiple inner friction plates 71 and the multiple outer friction plates 72 are engaged with each other, and the clutch 70 is in the engaged state. Therefore, the torque transmission between the input shaft 61 and the output shaft 62 is permitted.

At this time, the disk spring 81 rotates relative to the driven cam 50 and the disk spring retainer 82 while being bearing-supported by the thrust bearing 83. In this way, the thrust bearing 83 bearing-supports the disk spring 81 while receiving a load in a thrust direction from the disk spring 81.

When a clutch transmission torque reaches a clutch required torque capacity, the ECU 10 stops the rotation of the motor 20. Accordingly, the clutch 70 is in an engagement maintaining state where the clutch transmission torque is maintained at the clutch required torque capacity. In this way, the disk spring 81 of the state changing unit 80 can receive a force in the axial direction from the driven cam 50, and can change the state of the clutch 70 to the engaged state or the non-engaged state according to the relative position of the driven cam 50 in the axial direction with respect to the housing 12 and the drive cam 40.

An end portion of the shaft portion 621 on a side opposite to the plate portion 622 is connected to an input shaft of a transmission (not shown), and the output shaft 62 is rotatable together with the input shaft. That is, the torque output from the output shaft 62 is input to the input shaft of the transmission. The torque input to the transmission is changed in speed by the transmission, and is output to a drive wheel of the vehicle as a drive torque. Accordingly, the vehicle travels.

Next, the 3k-type strange planetary gear speed reducer employed by the speed reducer 30 according to the present embodiment will be described.

In an electric clutch device as in the present embodiment, it is required to shorten a time required for an initial response to reduce an initial gap (corresponding to the gap Sp1) between a clutch and an actuator. In order to speed up the initial response, it is understood from a rotational motion equation that an inertia moment around an input shaft is required to be reduced. The inertia moment when the input shaft is a solid cylindrical member increases in proportion to a fourth power of an outer diameter when a length and density are constant. In the clutch device 1 according to the present embodiment, the sun gear 31 corresponding to the “input shaft” here is a hollow cylindrical member, and this tendency does not change.

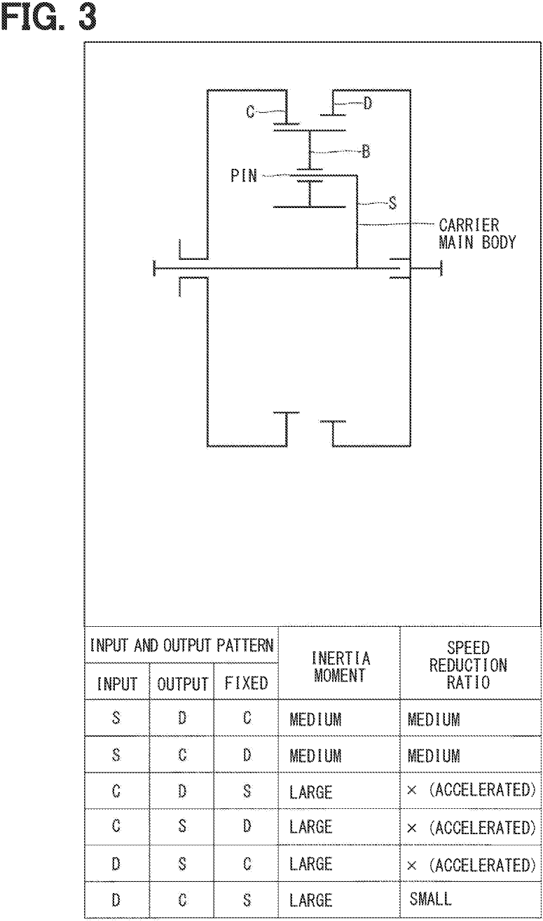

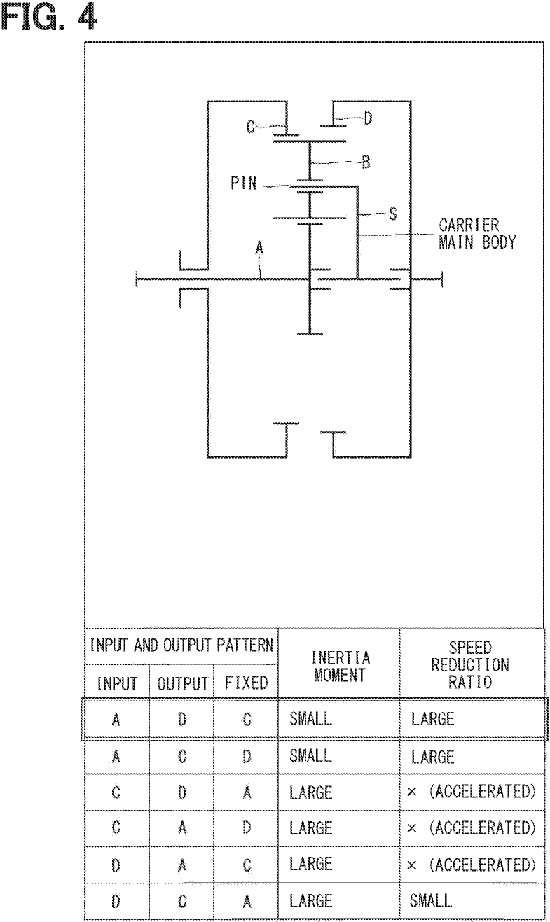

An upper part of FIG. 3 shows a schematic diagram of a 2kh-type strange planetary gear speed reducer. In addition, an upper part of FIG. 4 shows a schematic diagram of the 3k-type strange planetary gear speed reducer. Here, the sun gear is referred to as A, the planetary gear is referred to as B, the first ring gear is referred to as C, the second ring gear is referred to as D, and the carrier is referred to as S. Comparing the 2kh-type and the 3k-type, the 3k-type has a configuration in which the sun gear A is added to the 2kh-type.

In the case of the 2kh-type, when the carrier S located on a most radially inner side among the components is used as an input element, the inertia moment around the input shaft is the smallest (see a table in a lower part of FIG. 3).

On the other hand, in the case of the 3k-type, when the sun gear A located on a most radially inner side among the components is used as an input element, the inertia moment around the input shaft is the smallest (see a table in a lower part of FIG. 4).

A magnitude of the inertia moment is larger in the case of the 2kh-type strange planetary gear speed reducer using the carrier S as an input element than in the case of the 3k-type strange planetary gear speed reducer using the sun gear A as an input element. Therefore, in an electric clutch device in which a speed of the initial response is required, when a strange planetary gear speed reducer is employed as the speed reducer, it is desirable that the 3k-type is used and the sun gear A is used as an input element.

In addition, in the electric clutch device, the required load is very large from several thousand to ten thousand N, and in order to achieve both a high response and a high load, it is necessary to increase a speed reduction ratio of the speed reducer. Comparing maximum speed reduction ratios of the same gear specifications of the 2kh-type and the 3k-type, the maximum speed reduction ratio of the 3k-type is about 2 times the maximum speed reduction ratio of the 2kh-type, which is large. In addition, in the case of the 3k-type, when the sun gear A having a smallest inertia moment is used as an input element, a large speed reduction ratio can be obtained (see the table in the lower part of FIG. 4). Therefore, it can be said that an optimal configuration for achieving both the high response and the high load is a configuration in which the 3k-type is used and the sun gear A is used as an input element.

In the present embodiment, the speed reducer 30 is a 3k-type strange planetary gear speed reducer in which the sun gear 31(A) is used as an input element, the second ring gear 35(D) is used as an output element, and the first ring gear 34(C) is used as a fixed element. Therefore, an inertia moment around the sun gear 31 can be reduced, and a speed reduction ratio of the speed reducer 30 can be increased. Therefore, both the high response and the high load in the clutch device 1 can be achieved.

In the case of the 2kh-type, since the carrier S directly contributes to power transmission, in a configuration in which the planetary gear B is supported in a cantilever manner on a main body of the carrier S by a pin, there is a concern that a large bending moment may act between a rotation support shaft (pin) of the planetary gear B and the main body of the carrier S (see the schematic diagram in the upper part of FIG. 3).

On the other hand, in the case of the 3k-type, since the carrier S has only a function of holding the planetary gear B at an appropriate position with respect to the sun gear A, the first ring gear C, and the second ring gear D, the bending moment acting between the rotation support shaft (pin) of the planetary gear B and the main body of the carrier S is small (see the schematic diagram in the upper part of FIG. 4).

Therefore, in the present embodiment, by making the speed reducer 30 as a 3k-type strange planetary gear speed reducer have a high response and a high load, the planetary gear 32 can be supported from one side in the axial direction, that is, can be supported in a cantilever manner by the carrier main body 330 and the pin 331 without impairing responsiveness and durability of the clutch device 1.

Next, an effect of the state changing unit 80 including the disk spring 81 as the elastic deformation portion will be described.

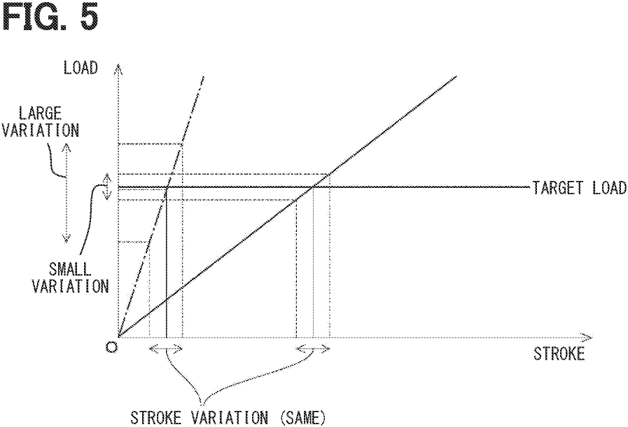

As shown in FIG. 5, regarding a relationship between the movement of the driven cam 50 in the axial direction, that is, the stroke and a load acting on the clutch 70, when comparing a configuration in which the clutch 70 is pushed by a rigid body that is difficult to elastically deform in the axial direction (see an alternate long and short dash line in FIG. 5) and a configuration in which the clutch 70 is pushed by the disk spring 81 that is elastically deformable in the axial direction as in the present embodiment (see a solid line in FIG. 5), it can be seen that, when variations in the stroke are the same, a variation in the load acting on the clutch 70 is smaller in the configuration in which the clutch 70 is pushed by the disk spring 81 than in the configuration in which the clutch 70 is pushed by the rigid body. This is because, as compared with the configuration in which the clutch 70 is pushed by the rigid body, a combined spring constant can be reduced by using the disk spring 81, so that the variation in the load with respect to the variation in the stroke of the driven cam 50 caused by the actuator can be reduced. In the present embodiment, since the state changing unit 80 includes the disk spring 81 as the elastic deformation portion, the variation in the load with respect to the variation in the stroke of the driven cam 50 can be reduced, and a target load can be easily applied to the clutch 70.

Next, a configuration and the like of the bearing portion 151 will be described in detail.

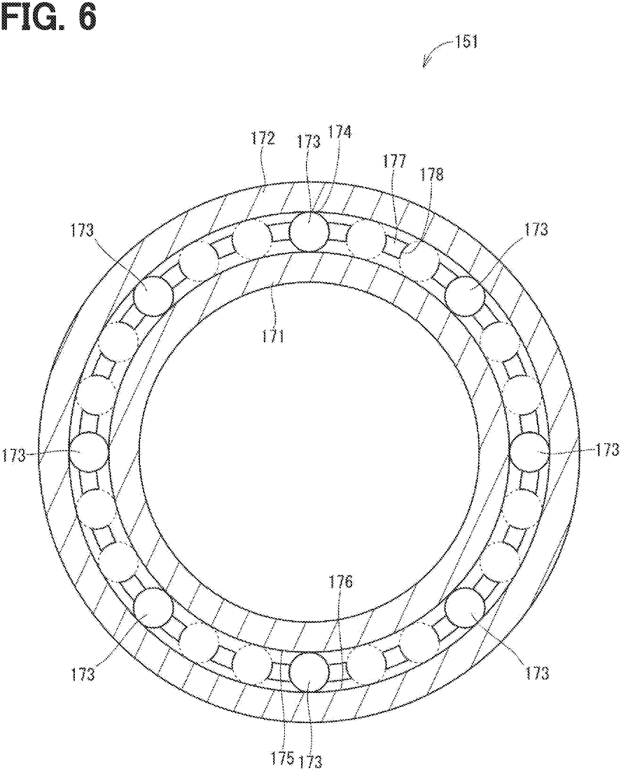

As shown in FIG. 6, the bearing portion 151 includes multiple bearing rolling bodies 173 that roll in the circumferential direction of the rotor 23 and rotatably support the rotor 23, and a lubricant 174 that lubricates a periphery of the bearing rolling bodies 173. The bearing portion 151 rotatably supports the rotor 23 via the sun gear 31. Here, only one bearing portion 151 that rotatably supports the rotor 23 is provided.

More specifically, the bearing portion 151 includes an inner ring 171, an outer ring 172, the bearing rolling bodies 173, the lubricant 174, a retainer 177, and the like.

The inner ring 171 is formed of, for example, metal in a substantially cylindrical shape. The outer ring 172 is formed of, for example, metal in a substantially cylindrical shape. An inner diameter of the outer ring 172 is larger than an outer diameter of the inner ring 171. An inner peripheral wall of the inner ring 171 is fitted to the outer peripheral wall of the housing small inner cylinder portion 126. An outer peripheral wall of the outer ring 172 is fitted to the one end portion of the sun gear main body 310, that is, an inner peripheral wall of an end portion on a side opposite to the sun gear tooth portion 311.

An annular inner ring groove portion 175 recessed to the radially inner side is formed on an outer peripheral wall of the inner ring 171. An annular outer ring groove portion 176 recessed to the radially outer side is formed on an inner peripheral wall of the outer ring 172.

The bearing rolling bodies 173 are each formed of, for example, metal in a spherical shape. The multiple bearing rolling bodies 173 are provided to be able to roll between the inner ring groove portion 175 of the inner ring 171 and the outer ring groove portion 176 of the outer ring 172.

The retainer 177 is formed in an annular shape or a tubular shape. The retainer 177 is provided between the inner ring 171 and the outer ring 172. Multiple holding hole portions 178 are formed in the retainer 177. For example, 24 holding hole portions 178 are formed at equal intervals in a circumferential direction of the retainer 177.

The bearing rolling body 173 is provided to be held by the holding hole portion 178. For example, eight bearing rolling bodies 173 are provided at equal intervals in the circumferential direction of the retainer 177. That is, the bearing rolling bodies 173 are provided in the holding hole portions 178 arranged in the circumferential direction of the retainer 177 with every two being skipped. The holding hole portion 178 can hold the bearing rolling body 173 such that the bearing rolling body 173 can roll between the inner ring 171 and the outer ring 172.

In the present embodiment, the number (8) of the bearing rolling bodies 173 is smaller than the number (24) of the holding hole portions 178.

The lubricant 174 is, for example, a fluid such as grease. The lubricant 174 is provided in the periphery of the bearing rolling bodies 173, the inner ring groove portion 175, the outer ring groove portion 176, and the holding hole portions 178 of the retainer 177, and lubricates the periphery of the bearing rolling bodies 173. Accordingly, the bearing rolling body 173 can smoothly roll between the inner ring 171 and the outer ring 172 in the holding hole portion 178.

A kinematic viscosity of the lubricant 174 varies depending on an environmental temperature. The lubricant 174 has a higher kinematic viscosity as the environmental temperature is lower, for example.

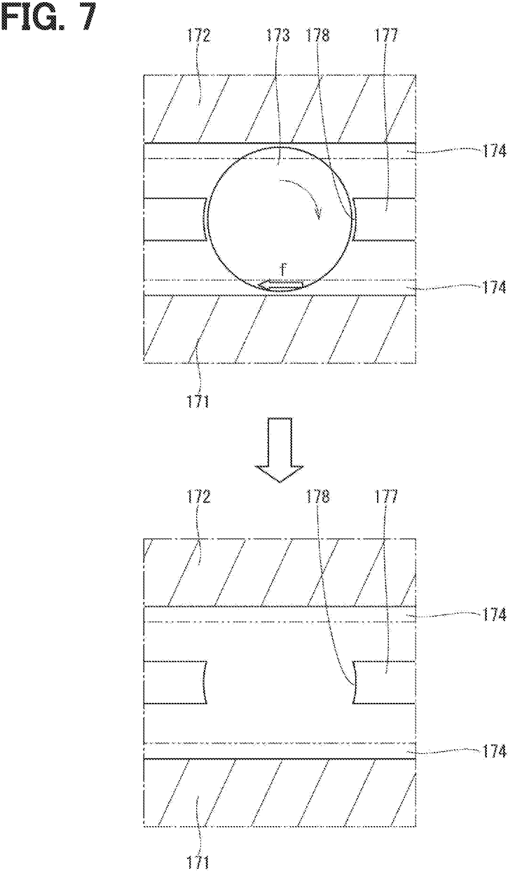

As shown in an upper part of FIG. 7, when the bearing rolling body 173 rolls between the inner ring 171 and the outer ring 172, the bearing rolling body 173 rolls while repelling the surrounding lubricant 174. Therefore, a resistance f for repelling the lubricant 174 is applied to the rolling bearing rolling body 173. Here, a total resistance of the bearing portion 151 is a value obtained by multiplying f by the number of bearing rolling bodies 173.

On the other hand, as shown in a lower part of FIG. 7, when the bearing rolling body 173 is removed from the holding hole portion 178, the above resistance f is not generated in the holding hole portion 178 from which the bearing rolling body 173 is removed. Therefore, by reducing the number of bearing rolling bodies 173 provided in the bearing portion 151, a total value of the resistances in the bearing portion 151 can be reduced. Accordingly, the starting torque of the bearing portion 151 can be reduced.

Next, the starting torque of the bearing portion 151 according to the present embodiment and a starting torque of the bearing portion 151 according to a comparative embodiment will be described.

In the bearing portion 151 according to the comparative embodiment, the bearing rolling bodies 173 are provided in all of the 24 holding hole portions 178 formed in the retainer 177. That is, in the comparative embodiment, the bearing portion 151 includes 24 bearing rolling bodies 173. As the number of bearing rolling bodies provided in the same bearing portion, 24 is a general (standard) number.

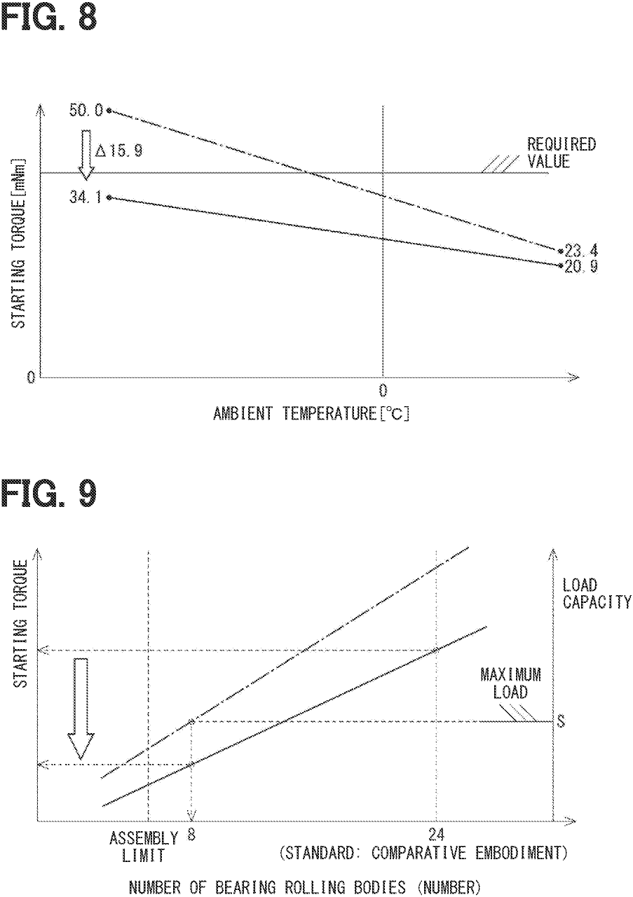

As shown in FIG. 8, the starting torque of the bearing portion 151 according to the present embodiment having eight bearing rolling bodies 173 (see a solid line in FIG. 8) is smaller than the starting torque of the bearing portion 151 according to the comparative embodiment having 24 bearing rolling bodies 173 (see an alternate long and short dash line in FIG. 8), regardless of an ambient temperature (environmental temperature). That is, by reducing the number of bearing rolling bodies 173, the starting torque of the bearing portion 151 can be reduced.

In particular, in a cryogenic range, by changing the number of bearing rolling bodies 173 from 24 (comparative embodiment) to eight (present embodiment), the starting torque of the bearing portion 151 can be reduced by 15.9 (mNm) (see FIG. 8).

The starting torque of the bearing portion 151 according to the present embodiment having eight bearing rolling bodies 173 satisfies a required value regardless of the ambient temperature (see FIG. 8).

A solid line in FIG. 9 indicates a relationship between the number of bearing rolling bodies 173 in the bearing portion 151 and the starting torque of the bearing portion 151 (vertical axis on a left side in FIG. 9). An alternate long and short dash line in FIG. 9 indicates a relationship between the number of bearing rolling bodies 173 in the bearing portion 151 and a load capacity of the bearing portion 151 (vertical axis on a right side in FIG. 9).

As shown in FIG. 9, a maximum value of the load (stress) applied to the bearing portion 151 is S. In addition, when the number of bearing rolling bodies 173 is equal to or smaller than an assembly limit (range in which an assembly condition of the bearing portion 151 is satisfied), the bearing rolling bodies 173 may come off between the inner ring 171 and the outer ring 172.

In the present embodiment, the number of bearing rolling bodies 173 is set to eight, which is a smallest possible number within a range in which the load (stress) applied to the bearing portion 151 can be withstood and a range in which the assembly condition of the bearing portion 151 is satisfied (see FIG. 9). Accordingly, the starting torque of the bearing portion 151 can be reduced as compared with the comparative example in which the number of bearing rolling bodies 173 is 24, while limiting a decrease in durability of the bearing portion 151.

An inner peripheral wall of the bearing portion 151, that is, the inner peripheral wall of the inner ring 171, is fitted to the outer peripheral wall of the housing inner cylinder portion 121. The sun gear 31 is provided such that an inner peripheral wall of the sun gear main body 310 is fitted to an outer peripheral wall of the bearing portion 151, that is, the outer peripheral wall of the outer ring 172. Accordingly, the rotor 23 is rotatably supported by the housing inner cylinder portion 121 via the sun gear 31 and the bearing portion 151. That is, the bearing portion 151 rotatably supports the rotor 23.

In this way, in the present embodiment, only one bearing portion 151 that rotatably supports the rotor 23 is provided.

The speed reducer 30 includes the sun gear 31 as an “input unit” that is provided rotatably integrally with and coaxially with the rotor 23, and that receives the torque from the rotor 23. In this way, in the present embodiment, the speed reducer 30 is a non-eccentric planetary speed reducer including no eccentric portion that is eccentric with respect to the rotor 23.

Next, releasing of the clutch 70 when a power supply failure occurs will be described.

In the clutch device 1 including the electric motor 20 as a driving source as in the present embodiment, when a power supply failure occurs due to disconnection of a power line (the coil 22 or the like) of the motor 20 or the like, it may be required to quickly remove the load being transmitted to the clutch 70, that is, to release the clutch 70.

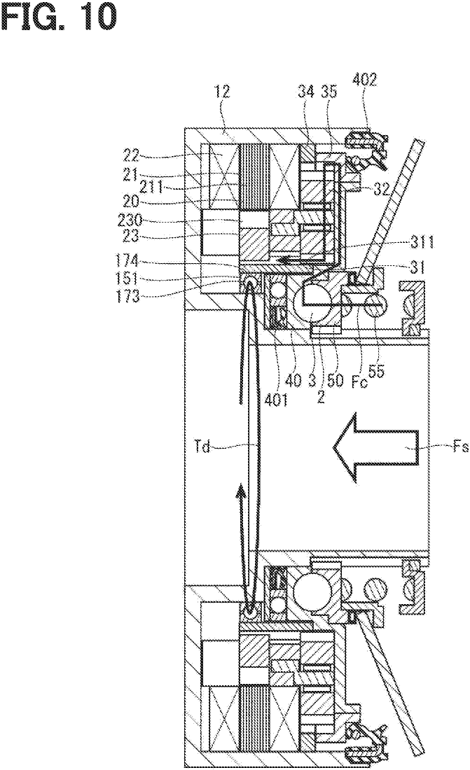

As shown in FIG. 10, a return spring load Fs, which is a load of the return spring 55, acts on the driven cam 50 of the ball cam 2. The return spring load is the same as a ball cam load (Fc), which is a load acting on the ball cam 2 when a movement amount of the driven cam 50 toward the clutch 70, that is, a stroke amount is 0.

When the return spring load (ball cam load) acts on the driven cam 50, a drive cam driven torque, which is a torque for rotating the drive cam 40, is generated. When the drive cam driven torque is generated, a rotor driven torque, which is a torque for rotating the rotor 23, is generated via the speed reducer 30. Here, a rotor detent torque (Td), which is a torque against the rotor driven torque, is generated in the rotor 23. The rotor detent torque includes a cogging torque of the motor 20 and a bearing loss torque, which is the starting torque of the bearing portion 151.

FIG. 11 is a diagram showing individual relationships between the stroke amount of the driven cam 50 toward the clutch 70, and the ball cam load (solid line), the return spring load (alternate long and short dash line), and a clutch load (dashed line), which is the load acting on the clutch 70. As shown in FIG. 11, when the stroke amount of the driven cam 50 toward the clutch 70 is 0, a lower limit value of the return spring load and a lower limit value of the ball cam load coincide with each other. Here, a release condition of the clutch 70 is that the rotor driven torque (lower limit) due to the drive cam driven torque due to the return spring load when the stroke amount of the driven cam 50 is 0 is larger than the rotor detent torque (upper limit).

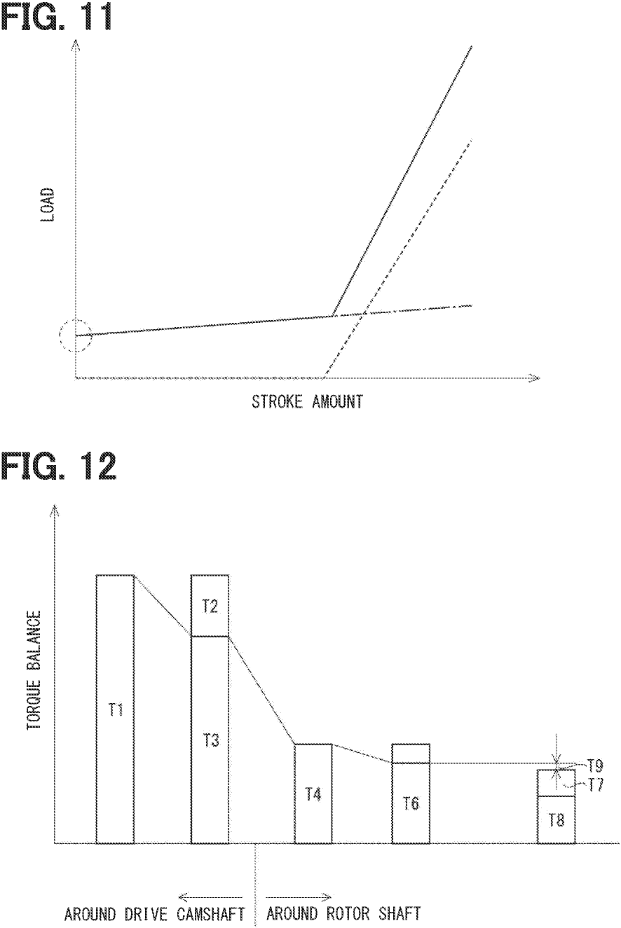

In FIG. 12, T1 is the drive cam driven torque. T2 is a loss torque that is a torque lost in an inner sealing member 401, an outer sealing member 402, and a thrust bearing 161 when the drive cam 40 rotates. T3 is a torque obtained by subtracting T2 from T1. T4 is a torque obtained by dividing T3 by the speed reduction ratio of the speed reducer 30. T6 is a torque obtained by multiplying T4 by reverse efficiency of the speed reducer 30, and is the rotor driven torque. T7 is a torque obtained by dividing the cogging torque of the motor 20 by 2. T8 is the bearing loss torque of the bearing portion 151. The rotor detent torque is a sum of T7 and T8. T9 is a margin torque that is a difference between the rotor driven torque (T6) and the rotor detent torque (T7 + T8). In the present embodiment, the margin torque (T9) is set to a value at which the clutch 70 can be released within a predetermined time when the power supply failure occurs.

A basic equation of the release condition of the clutch 70 is expressed by the following Equation 1.

$$\begin{matrix}\text{Lower} \text{limit} \text{of} \text{rotor} \text{driver} \text{torque} \left(\text{T6}\right) - \\ \text{upper} \text{limit} \text{of} \text{rotor} \text{detent} \text{torque} \left(\text{T7} + \text{T8}\right) > 0\end{matrix} \qquad \text{Equation 1}$$

Upper limit of rotor detent torque (T7 + T8) is expressed by the following Equation 2.

$$\begin{matrix}\text{Upper} \text{limit} \text{of} \text{rotor} \text{detent} \text{torque} \left(\text{T7} + \text{T8}\right) = \\ \text{upper} \text{limit} \text{of} \text{cogging} \text{torque} / 2 + \\ \text{upper} \text{limit} \text{of} \text{bearing} \text{loss} \text{torque} \left(\text{T} 8\right)\end{matrix} \qquad \text{Equation 2}$$

Lower limit of rotor driven torque (T6) is expressed by the following Equation 3.

$$\begin{matrix}\text{Lower} \text{limit} \text{of} \text{rotor} \text{driven} \text{torque} \left(\text{T6}\right) = \\ \left\{\text{drive} \text{cam} \text{driven} \text{torque} \left(\text{T} 1\right) - \text{loss} \text{torque} \left(\text{T} 2\right)\right\} \div \\ \text{speed} \text{reduction} \text{ratio} \times \text{lower} \text{limit} \text{of} \text{reverse} \text{efficiency}\end{matrix} \qquad \text{Equation 3}$$

The drive cam driven torque (T1) is expressed by the following Equation 4.

$$\begin{matrix}\text{Drive} \text{cam} \text{driven} \text{torque} \left(\text{T1}\right) = \\ \text{lower} \text{limit} \text{of} \text{ball} \text{cam} \text{load} \div \\ \text{upper} \text{limit} \text{of} \text{ball} \text{cam} \text{conversion} \text{ratio} \times \\ \text{lower} \text{limit} \text{of} \text{ball} \text{cam} \text{reverse} \text{efficiency}\end{matrix} \qquad \text{Equation 4}$$

The ball cam conversion ratio in Equation 4 is a load that can be output when 1 Nm is applied to the drive cam 40 without friction. The ball cam reverse efficiency is reverse efficiency of the ball cam 2.

As described above, in order to drive the rotor 23 only by the return spring load, it is essential to reduce the starting torque (bearing loss torque) of the bearing portion 151.

Next, an operation example of releasing the clutch 70 when the power supply failure occurs will be described.

In the clutch device 1 including the electric motor 20 as a driving source as in the present embodiment, a motor torque is generated by energizing the motor 20, is increased by the speed reducer 30, is input to the ball cam 2, and is converted into a load for output. In the speed reducer 30 and the ball cam 2, since power loss occurs due to friction, when the clutch 70 is pushed (normal operation) and when the clutch 70 is pushed back (reverse operation), a difference occurs in the motor torque when the motor torque is balanced with the same load (ACT load hysteresis characteristic: see FIG. 13).

An ACT conversion ratio (without friction), which is a conversion ratio of the actuator of the clutch device 1, is expressed by the following Equation 5.

$$\begin{matrix}\text{ACT} \text{conversion} \text{ratio} \left(\text{without} \text{friction}\right) = \\ \text{speed} \text{reduction} \text{ratio} \times \text{conversion} \text{ratio}\end{matrix} \qquad \text{Equation 5}$$

A normal operation ACT conversion ratio (without friction), which is an ACT conversion ratio during the normal operation, is expressed by the following Equation 6.

$$\begin{matrix}\text{Normal} \text{operation} \text{ACT} \text{conversion} \text{ratio} \left(\text{without} \text{friction}\right) = \\ \text{ACT} \text{conversion} \text{ratio} \left(\text{without} \text{friction}\right) \times \\ \text{speed} \text{reducer} \text{normal} \text{efficiency} \times \text{ball} \text{cam} \text{normal} \text{efficiency}\end{matrix} \qquad \text{Equation 6}$$

The speed reducer normal efficiency in Equation 6 is normal efficiency of the speed reducer 30. The ball cam normal efficiency is normal efficiency of the ball cam 2.

A reverse operation ACT conversion ratio (without friction), which is an ACT conversion ratio during the reverse operation, is expressed by the following Equation 7.

$$\begin{matrix}\text{Reverse} \text{operation} \text{ACT} \text{conversion} \text{ratio} \left(\text{without} \text{friction}\right) = \\ \text{ACT} \text{conversion} \text{ratio} \left(\text{without} \text{friction}\right) \times \\ \text{speed} \text{reducer} \text{reverse} \text{efficiency} \times \text{ball} \text{cam} \text{reverse} \text{efficiency}\end{matrix} \qquad \text{Equation 7}$$

The speed reducer reverse efficiency in Equation 7 is reverse efficiency of the speed reducer 30. The ball cam reverse efficiency is reverse efficiency of the ball cam 2.

A slope of a graph of the ACT load hysteresis characteristic (see FIG. 13) corresponds to the ACT conversion ratio.

Assume that the speed reduction ratio is 60, the speed reducer normal efficiency is 80%, the speed reducer reverse efficiency is 80%, the ball cam conversion ratio, which is a load that can be output when 1 Nm is applied to the drive cam 40 without friction, is 300 N/Nm, the ball cam normal efficiency is 90%, and the ball cam reverse efficiency is 90%, the load during the normal operation is expressed by the following Equation 8.

$$\begin{matrix}\text{Normal} \text{operation} : \text{load} = \text{motor} \text{torque} \text{MT1} \times \\ \text{speed} \text{reduction} \text{ratio} \times \text{speed} \text{reducer} \text{normal} \text{efficiency} \times \\ \text{conversion} \text{ratio} \times \text{ball} \text{cam} \text{normal} \text{efficiency}\end{matrix} \qquad \text{Equation 8}$$

On the other hand, the load during the reverse operation is expressed by the following Equation 9.

$$\begin{matrix}\text{Reverse} \text{operation} : \text{load} = \text{motor} \text{torque} \text{MT2} \times \\ \text{speed} \text{reduction} \text{ratio} \div \text{speed} \text{reducer} \text{reverse} \text{efficiency} \times \\ \text{conversion} \text{ratio} \div \text{ball} \text{cam} \text{reverse} \text{efficiency}\end{matrix} \qquad \text{Equation 9}$$

When the Equations 8 and 9 are simultaneously set for the load, the following Equation 10 is obtained.

$$\begin{matrix}\text{Motor} \text{torque} \text{MT2} / \text{motor} \text{torque} \text{MT1} = \\ \text{speed} \text{reduer} \text{normal} \text{efficiency} \times \text{speed} \text{teducer} \text{reverse} \text{efficiency} \times \\ \text{ball} \text{cam} \text{normal} \text{efficiency} \times \text{ball} \text{cam} \text{reverse} \text{efficiency} \approx 0.52\end{matrix} \qquad \text{Equation 10}$$

As expressed by Equation 10, during the reverse operation, the motor torque balanced with the same load is about half of the motor torque during the normal operation.

In order to release the clutch 70 when the power supply failure occurs, it is necessary to reversely drive the rotor 23 only by the return spring load. The return spring load is set to be significantly smaller than a fastening load of the clutch 70. Therefore, the rotor driven torque by the return spring 55 is similarly small.

For example, when the motor 20 can output 1 Nm at maximum at the above specifications, the maximum output load is 1 × 60 × 0.8 × 300 × 0.9 = 13000 (N), and if a required load of the clutch 70 is 10000 N, the remaining 3000 N can be set to the return spring load. However, since it is necessary to give a margin for the motor torque in practice, the return spring load is preferably set to about 1000 N to 2000 N.

The driven torque of the rotor 23 generated by the load of 1000 N is 1000/300 × 0.9/60 × 0.8 = 40 (mNm), and if the driven torque exceeds the detent torque of the rotor 23 (cogging torque/2 + bearing loss torque), the clutch 70 can be released only by the return spring load.

At a low temperature, since the kinematic viscosity of the lubricant 174 increases, a shear resistance of the lubricant 174 generated between the bearing rolling bodies 173 and the retainer 177, the inner ring 171, and the outer ring 172 increases. Therefore, the bearing loss torque of the detent torque tends to increase in a low-temperature range, and for example, in the comparative example in which the number of bearing rolling bodies 173 of the bearing portion 151 is 24 (standard), a situation may occur in which “the clutch 70 can be released in a high-temperature range, but cannot be released in the low-temperature range”. In order to avoid this situation, in the present embodiment, the number of bearing rolling bodies 173 of the bearing portion 151 is reduced from 24 in the comparative example to eight, and the bearing loss torque is kept low even at a low temperature, so that the clutch 70 can be released in the entire temperature range.

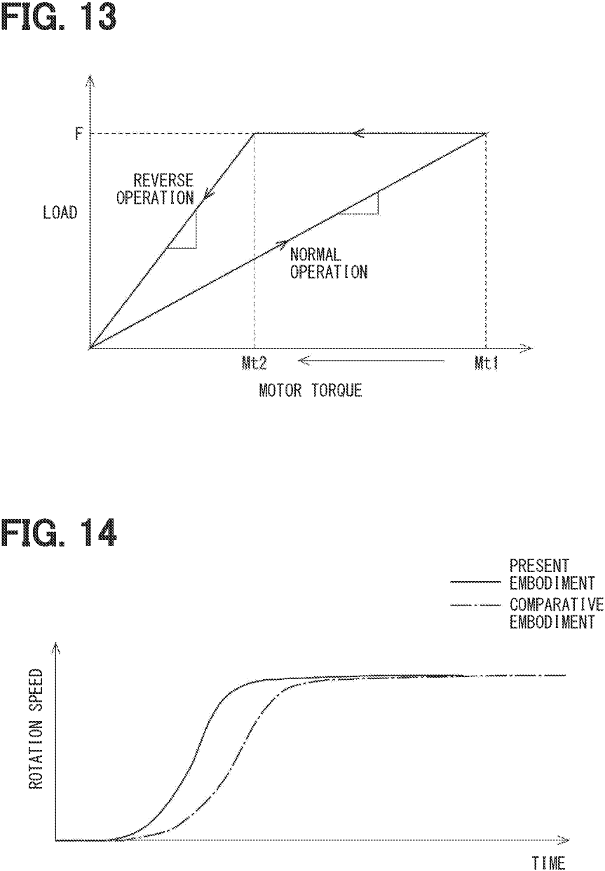

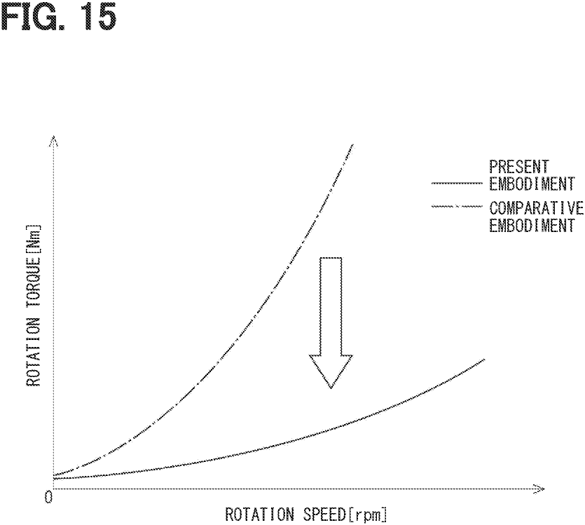

In the present embodiment, by reducing the number of bearing rolling bodies 173 of the bearing portion 151, an effect is also exerted that the inertia moment of the rotor 23 is reduced, startability is improved, and the responsiveness is improved. Since the responsiveness, particularly when a clearance (initial gap: Sp1) between the state changing unit 80 and the clutch 70 is reduced, depends on a speed at which the rotation speed of the motor 20 rises (see FIG. 14), reducing the inertia moment by reducing the number of bearing rolling bodies 173 is effective in improving the responsiveness.

As shown in FIG. 15, by reducing the number of bearing rolling bodies 173 of the bearing portion 151 from 24 in the comparative embodiment to eight, the rotation torque of the motor 20 can be reduced particularly in a high rotation speed range even at an extremely low temperature. Therefore, the responsiveness of the motor 20 can be improved.

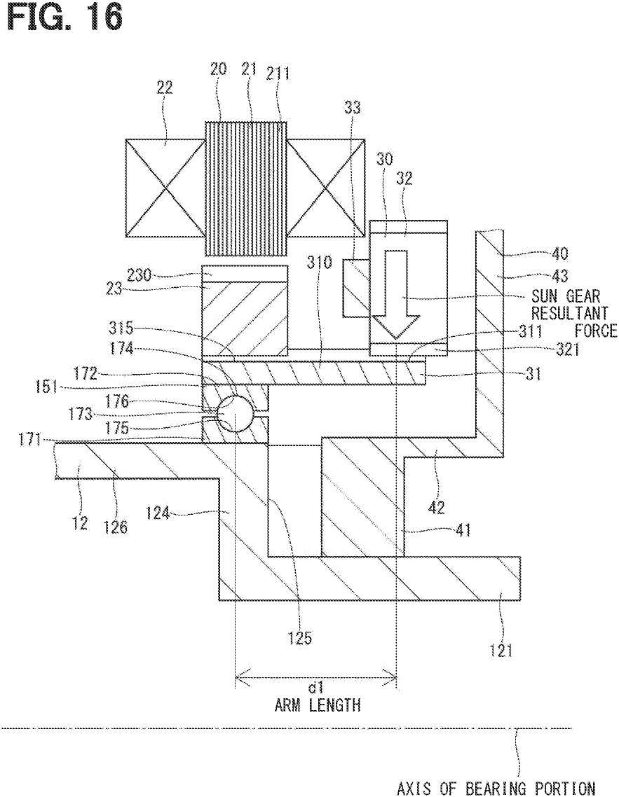

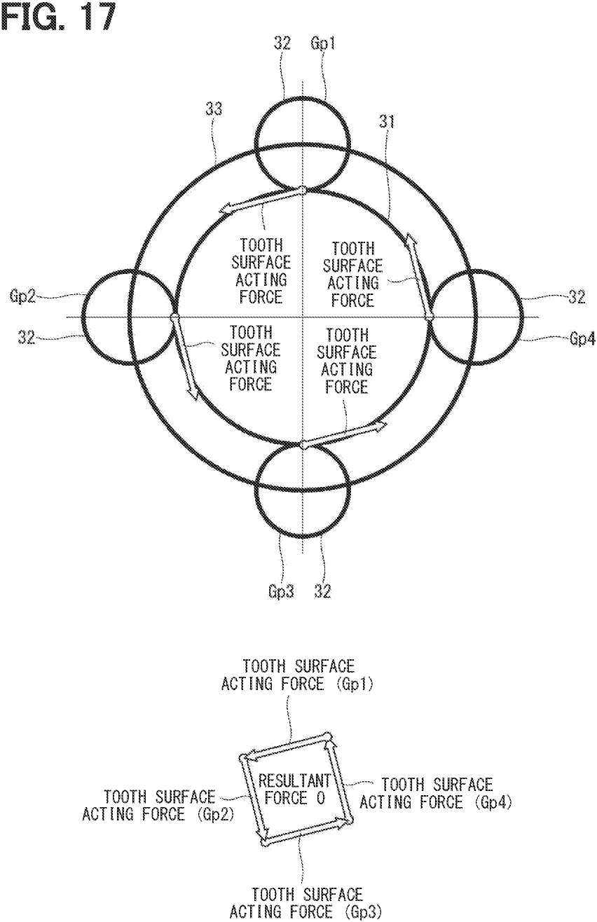

The bearing portion 151 is a “ball bearing”. More specifically, the bearing portion 151 is a “single-row ball bearing” in which the bearing rolling bodies 173 are arranged in one row in the axial direction of the inner ring 171 and the outer ring 172 (see FIG. 16).

In the axial direction of the bearing portion 151, the bearing portion 151 is provided to be separated from the sun gear tooth portion 311 as an “input unit” (see FIG. 16).

More specifically, in the axial direction of the bearing portion 151, a center position of the bearing portion 151 and a “sun gear load acting position”, which is a center position of the sun gear tooth portion 311 and on which a load acts on the sun gear 31, are separated by a distance d1 (see FIG. 16).

Next, actions and the like of the speed reducer 30 and the bearing portion 151 having the above configuration will be described.

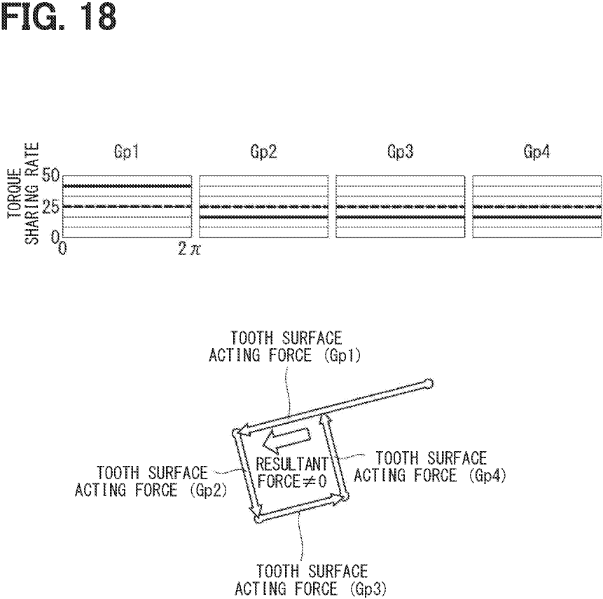

As shown in an upper part of FIG. 17, four planetary gears 32 are provided at equal intervals in the circumferential direction of the sun gear 31 on the radially outer side of the sun gear 31. Here, for the sake of description, the four planetary gears 32 are referred to as planetary gears Gp1, Gp2, Gp3, Gp4 in a counterclockwise direction.

In an ideal gear shape, a torque sharing rate of each planetary gear 32 (Gp1 to Gp4) is constant. Therefore, tooth surface acting forces acting on the sun gear 31 from the planetary gears 32 (Gp1 to Gp4) cancel each other out, and a resultant force is zero (see a lower part of FIG. 17).

FIG. 18 shows an example in which the torque sharing rates of the planetary gears 32 (Gp1 to Gp4) are not uniform. When there are four planetary gears 32 in the present embodiment, an average torque sharing rate is 25%. As shown in an upper part of FIG. 18, when the torque sharing rate of only the planetary gear Gp1 is higher than 25% and the torque sharing rates of the planetary gears Gp2 to Gp4 are constant and are lower than 25%, the resultant force of the tooth surface acting forces acting on the sun gear 31 is not zero (see a lower part of FIG. 18).

Therefore, in the present embodiment, the carrier 33 has a configuration in which an inner peripheral wall does not come into contact with the outer peripheral wall of the sun gear 31 or the like, that is, a floating type. Accordingly, theoretically, torque distribution rates of the planetary gears 32 (Gp1 to Gp4) can be made close to constant.

Therefore, the resultant force of the tooth surface acting forces acting on the sun gear 31, that is, a sun gear resultant force is small. Accordingly, even though the center position of the bearing portion 151 and the sun gear load acting position are separated by the distance d1 in the axial direction of the bearing portion 151 (see FIG. 16), a bending moment that is a product of an arm length (d1) and the sun gear resultant force is locally minimized. That is, in the speed reducer 30 which is a non-eccentric planetary speed reducer having no eccentric portion as in the present embodiment, a tooth surface load generated on the torque transmission portion (between the sun gear tooth portion 311 and the planetary gear tooth portion 321) is zero or very small in the radial direction.

The motor 20 includes the magnet 230 as a “permanent magnet” provided on the rotor 23 (see FIG. 16). Here, the magnet 230 is provided on the outer peripheral wall of the rotor 23. That is, the motor 20 is a surface magnet-type (SPM) motor.

Hereinafter, the configuration of each portion of the present embodiment will be described in more detail.

In the present embodiment, the clutch device 1 includes an oil supply portion 5 (see FIGS. 1 and 2). The oil supply portion 5 is formed in a passage shape in the output shaft 62 such that one end is exposed to the clutch space 620. The other end of the oil supply portion 5 is connected to an oil supply source (not shown). Accordingly, oil is supplied from the one end of the oil supply portion 5 to the clutch 70 in the clutch space 620.

The ECU 10 controls an amount of oil supplied from the oil supply portion 5 to the clutch 70. The oil supplied to the clutch 70 can lubricate and cool the clutch 70. In this way, in the present embodiment, the clutch 70 is a wet clutch and can be cooled by oil.

In the present embodiment, the ball cam 2 as a “rotational translation unit” forms the accommodation space 120 between the drive cam 40 as a “rotation portion” and the housing 12, and between the second ring gear 35 and the housing 12. Here, the accommodation space 120 is formed on the inside of the housing 12 on a side opposite to the clutch 70 with respect to the drive cam 40 and the second ring gear 35. The motor 20 and the speed reducer 30 are provided in the accommodation space 120. The clutch 70 is provided in the clutch space 620, which is a space on a side opposite to the accommodation space 120 with respect to the drive cam 40.

In the present embodiment, the clutch device 1 includes the thrust bearing 161 and a thrust bearing washer 162. The thrust bearing washer 162 is formed of, for example, metal in a substantially annular plate shape, and is provided such that one surface is in contact with the housing step surface 125. The thrust bearing 161 is provided between the other surface of the thrust bearing washer 162 and a surface of the drive cam main body 41 on a side opposite to the driven cam 50. The thrust bearing 161 bearing-supports the drive cam 40 while receiving a load in the thrust direction from the drive cam 40. In the present embodiment, a load in the thrust direction acting on the drive cam 40 from the clutch 70 side via the driven cam 50 acts on the housing step surface 125 via the thrust bearing 161 and the thrust bearing washer 162. Therefore, the drive cam 40 can be stably bearing-supported by the housing step surface 125.

In the present embodiment, the clutch device 1 includes the inner sealing member 401 and the outer sealing member 402 as “seal members”.

The inner sealing member 401 and the outer sealing member 402 are oil seals annularly formed of an elastic material such as rubber and a metal ring.

An inner diameter and an outer diameter of the inner sealing member 401 are smaller than an inner diameter and an outer diameter of the outer sealing member 402.

The inner sealing member 401 is located between the housing inner cylinder portion 121 and the thrust bearing 161 in the radial direction, and is located between the thrust bearing washer 162 and the drive cam main body 41 in the axial direction. The inner sealing member 401 is fixed to the housing inner cylinder portion 121 and is rotatable relative to the drive cam 40.

The outer sealing member 402 is provided between the gear inner cylinder portion 355 of the second ring gear 35 and an end portion of the housing outer cylinder portion 123 on the clutch 70 side. The outer sealing member 402 is fixed to the housing outer cylinder portion 123 and is rotatable relative to the second ring gear 35.

Here, the outer sealing member 402 is provided to be located on the radially outer side of the inner sealing member 401 when viewed in the axial direction of the inner sealing member 401 (see FIGS. 1 and 2).

A surface of the drive cam main body 41 on a thrust bearing washer 162 side is slidable on a seal lip portion of the inner sealing member 401. That is, the inner sealing member 401 is provided to come into contact with the drive cam 40 as a “rotation portion”. The inner sealing member 401 seals the drive cam main body 41 and the thrust bearing washer 162 in an airtight or liquid-tight manner.

An outer peripheral wall of the gear inner cylinder portion 355 of the second ring gear 35 is slidable on a seal lip portion, which is an inner edge portion of the outer sealing member 402. That is, the outer sealing member 402 is provided to come into contact with the second ring gear 35 that rotates integrally with the drive cam 40 on the radially outer side of the drive cam 40 as a “rotation portion”. The outer sealing member 402 seals the outer peripheral wall of the gear inner cylinder portion 355 and the inner peripheral wall of the housing outer cylinder portion 123 in an airtight or liquid-tight manner.

By the inner sealing member 401 and the outer sealing member 402 provided as described above, the accommodation space 120 in which the motor 20 and the speed reducer 30 are accommodated and the clutch space 620 in which the clutch 70 is provided can be maintained in an airtight or liquid-tight manner. Accordingly, for example, even if a foreign matter such as abrasion powder is generated in the clutch 70, the foreign matter can be restricted from entering the accommodation space 120 from the clutch space 620. Therefore, an operation failure of the motor 20 or the speed reducer 30 caused by the foreign matter can be reduced.

In the present embodiment, since the accommodation space 120 and the clutch space 620 are maintained in an airtight or liquid-tight manner by the inner sealing member 401 and the outer sealing member 402, even if the foreign matter such as the abrasion powder is contained in the oil supplied to the clutch 70, the oil containing the foreign matter can be restricted from flowing into the accommodation space 120 from the clutch space 620.

In the present embodiment, the housing 12 is formed to have a closed shape from a portion corresponding to the radially outer side of the outer sealing member 402 to a portion corresponding to the radially inner side of the inner sealing member 401 (see FIGS. 1 and 2).

In the present embodiment, although the drive cam 40 and the second ring gear 35 forming the accommodation space 120 with the housing 12 rotate relative to the housing 12, the drive cam 40 and the second ring gear 35 do not move relative to the housing 12 in the axial direction. Therefore, when the clutch device 1 is operated, a change in capacity of the accommodation space 120 can be reduced, and generation of a negative pressure in the accommodation space 120 can be reduced. Accordingly, the oil or the like containing the foreign matter can be restricted from being suctioned into the accommodation space 120 from the clutch space 620.

The inner sealing member 401 to come into contact with the inner edge portion of the drive cam 40 slides on the drive cam 40 in the circumferential direction, but does not slide in the axial direction. In addition, the outer sealing member 402 to come into contact with the outer peripheral wall of the gear inner cylinder portion 355 of the second ring gear 35 slides on the second ring gear 35 in the circumferential direction, but does not slide in the axial direction.

As shown in FIG. 1, the drive cam main body 41 is located on a side opposite to the clutch 70 with respect to the drive cam outer cylinder portion 44. That is, the drive cam 40 as a “rotation portion” is bent in the axial direction to be formed such that the drive cam main body 41, which is the inner edge portion of the drive cam 40, and the drive cam outer cylinder portion 44, which is an outer edge portion of the drive cam 40, are located at different positions in the axial direction.

The driven cam main body 51 is provided to be located on the radially inner side of the drive cam inner cylinder portion 42 in the clutch 70 side of the drive cam main body 41. That is, the drive cam 40 and the driven cam 50 are provided in a nested manner in the axial direction.

More specifically, the driven cam main body 51 is located on the radially inner side of the gear plate portion 356, the gear outer cylinder portion 357 of the second ring gear 35, the drive cam plate portion 43, and the drive cam inner cylinder portion 42. In addition, the sun gear tooth portion 311 of the sun gear 31, the carrier 33, and the planetary gears 32 are located on the radially outer side of the drive cam main body 41 and the driven cam main body 51. Accordingly, a size of the clutch device 1 in the axial direction including the speed reducer 30 and the ball cam 2 can be significantly reduced.

In the present embodiment, as shown in FIG. 1, the drive cam main body 41, the sun gear 31, the carrier 33, and the coil 22 are arranged to partially overlap with each other in an axial direction of the drive cam main body 41. In other words, a part of the coil 22 is provided to be located on the radially outer side of a part of the drive cam main body 41, the sun gear 31, and the carrier 33 in the axial direction. Accordingly, the size of the clutch device 1 in the axial direction can be further reduced.

As shown in FIG. 1, in the present embodiment, the bearing portion 151 is provided on the radially inner side with respect to the sun gear tooth portion 311 as an “input unit” when viewed in the axial direction of the bearing portion 151. More specifically, when viewed in the axial direction of the bearing portion 151, an outer edge portion (outer peripheral wall of the outer ring 172) of the bearing portion 151 is provided to be located on the radially inner side with respect to an outer edge portion (tooth tip) of the sun gear tooth portion 311. Therefore, a size of the clutch device 1 in the radial direction can be reduced while ensuring sizes of the stator 21 and the rotor 23 in the radial direction.

As described above, in the present embodiment, the bearing portion 151 includes the multiple bearing rolling bodies 173 that roll in the circumferential direction of the rotor 23 and rotatably support the rotor 23, and the lubricant 174 that lubricates the periphery of the bearing rolling bodies 173. Here, only one bearing portion 151 that rotatably supports the rotor 23 is provided. The speed reducer 30 includes the sun gear tooth portion 311 as an “input unit” that is provided rotatably integrally with and coaxially with the rotor 23, and that receives the torque from the rotor 23.

In the present embodiment, when the torque is input from the motor 20 to the sun gear tooth portion 311, the sun gear tooth portion 311 rotates coaxially with the rotor 23. Therefore, a radial load acting on the sun gear tooth portion 311 from a gear or the like provided on the radially outer side of the sun gear tooth portion 311 can be reduced. Therefore, the number of bearing portion 151 that rotatably supports the rotor 23 can be one.

Since the radial load acting on the sun gear tooth portion 311 can be reduced, a decrease in durability can be reduced even if the number of bearing rolling bodies 173 of the bearing portion 151 is reduced. Therefore, the starting torque and rotation torque of the bearing portion 151 can be reduced. Accordingly, the responsiveness, especially at a low temperature can be improved, and a minimum set load required to remove the load on the clutch 70 when the power supply failure occurs can be reduced.

By reducing the number of bearing rolling bodies 173 of the bearing portion 151, an inertia moment of the rotor 23 can be reduced, and the responsiveness can be further improved.

In the present embodiment, the number of bearing rolling bodies 173 is set to a smallest possible number within a range in which the load applied to the bearing portion 151 can be withstood and a range in which the assembly condition of the bearing portion 151 is satisfied.

Therefore, the starting torque of the bearing portion 151 can be reduced while limiting the decrease in the durability of the bearing portion 151. Accordingly, the responsiveness can be further improved while ensuring the durability.

In the present embodiment, the bearing portion 151 includes the retainer 177 in which the multiple holding hole portions 178 that can hold the bearing rolling bodies 173 are formed. The number of bearing rolling bodies 173 is smaller than the number of holding hole portions 178.

In this way, by setting the number of bearing rolling bodies 173 to be smaller than the number of holding hole portions 178 formed in the retainer 177, the starting torque of the bearing portion 151 can be easily reduced, and the responsiveness can be improved.

In the present embodiment, the bearing portion 151 is a ball bearing.

Therefore, the durability and bearing-support accuracy of the bearing portion 151 can be improved. In addition, the bearing portion 151 is a single-row ball bearing. Therefore, a size of the bearing portion 151 in the axial direction can be reduced.

In the present embodiment, the bearing portion 151 is provided to be separated from the sun gear tooth portion 311 as an “input unit” in the axial direction of the bearing portion 151.

Therefore, a degree of freedom in design of the speed reducer 30 and the ball cam 2 can be secured, for example, a large space can be ensured by arranging a part of the speed reducer 30 and a part of the ball cam 2 in a nested manner.

In the speed reducer 30 which is a non-eccentric planetary speed reducer having no eccentric portion, the tooth surface load generated on the torque transmission portion (between the sun gear tooth portion 311 and the planetary gear tooth portion 321) is zero or very small in the radial direction. Therefore, even if the bearing portion 151 is provided to be separated from the sun gear tooth portion 311 in the axial direction of the bearing portion 151, the bending moment does not occur, and an influence on the durability of the bearing portion 151 is small. In addition, a large load in the radial direction does not act on the sun gear tooth portion 311, and the rotor 23 can be rotatably supported by the bearing portion 151.

In the present embodiment, the motor 20 includes the magnet 230 provided on the rotor 23. That is, the motor 20 is a brushless DC motor using the magnet 230 as a “permanent magnet”.

In the present embodiment, the inner sealing member 401 and the outer sealing member 402 can maintain the accommodation space 120 and the clutch space 620 in a liquid-tight manner. Accordingly, even if magnetic particles such as iron powder are contained in the oil supplied to the clutch 70 for cooling the clutch 70, the oil containing the magnetic particles can be restricted from flowing into the accommodation space 120 from the clutch space 620. Therefore, the magnetic particles can be restricted from being absorbed to the magnet 230 of the motor 20, and a decrease in rotation performance of the motor 20 and the operation failure can be reduced.

In the present embodiment, the speed reducer 30 includes the sun gear 31, the planetary gears 32, the carrier 33, the first ring gear 34, and the second ring gear 35. The torque of the motor 20 is input to the sun gear tooth portion 311 as an “input unit”. The planetary gears 32 can revolve in the circumferential direction of the sun gear tooth portion 311 (sun gear 31) while meshing with the sun gear tooth portion 311 (sun gear 31) and rotating on its axis.

The carrier 33 rotatably supports the planetary gears 32 and is rotatable relative to the sun gear tooth portion 311 (sun gear 31). The first ring gear 34 can mesh with the planetary gear 32. The second ring gear 35 can mesh with the planetary gear 32, is formed such that the number of teeth of the tooth portion is different from that of the first ring gear 34, and outputs the torque to the drive cam 40 of the ball cam 2.

In the present embodiment, the speed reducer 30 corresponds to a configuration having the highest response and the highest load among a number of configurations and input and output patterns of strange planetary gear speed reducers. Therefore, both the high response and the high load in the speed reducer 30 can be achieved.

In the present embodiment, as described above, the inner sealing member 401 and the outer sealing member 402 can maintain the accommodation space 120 and the clutch space 620 in a liquid-tight manner. Accordingly, an influence of oil containing fine iron powder on the speed reducer 30 as a “strange planetary gear speed reducer” having many meshing portions, for example, damage, wear, a decrease in principle efficiency, and the like can be reduced.

In the present embodiment, the first ring gear 34 is fixed to the housing 12. The second ring gear 35 is provided integrally and rotatably with the drive cam 40.

In the present embodiment, the responsiveness of the clutch device 1 can be improved by connecting each portion, as described above, such that an inertia moment of a high-speed rotation portion of the speed reducer 30 as a “strange planetary gear speed reducer” is reduced.

In the present embodiment, the “rotation portion” of the “rotational translation unit” is the drive cam 40 including the multiple drive cam grooves 400 formed on one surface in the axial direction. The “translation portion” is the driven cam 50 including the multiple driven cam grooves 500 formed on one surface in the axial direction. The “rotational translation unit” is the ball cam 2 including the drive cam 40, the driven cam 50, and the balls 3 provided to be able to roll between the drive cam grooves 400 and the driven cam grooves 500.

Therefore, efficiency of the “rotational translation unit” can be improved as compared with a case where the “rotational translation unit” is formed of, for example, a “sliding screw”. In addition, as compared with a case in which the “rotational translation unit” is formed of, for example, a “ball screw”, a cost can be reduced, a size of the “rotational translation unit” in the axial direction can be reduced, and the size of the clutch device can be further reduced.

In the present embodiment, the drive cam 40 as a “rotation portion” is formed such that the drive cam main body 41, which is the inner edge portion, and the drive cam outer cylinder portion 44, which is the outer edge portion, are located at different positions in the axial direction.

Therefore, the drive cam 40, the driven cam 50 as a “translation portion”, and the speed reducer 30 can be disposed in a nested manner in the axial direction, and the size of the clutch device 1 in the axial direction can be reduced.

In the present embodiment, the motor 20 and the speed reducer 30 are provided in the accommodation space 120 formed in the inside of the housing 12 on the side opposite to the clutch 70 with respect to the drive cam 40. The clutch 70 is provided in the clutch space 620, which is a space on a side opposite to the accommodation space 120 with respect to the drive cam 40.

The inner sealing member 401 and the outer sealing member 402 as “seal members” are formed in an annular shape, are provided to come into contact with the drive cam 40 as a “rotation portion” or the second ring gear 35 that rotates integrally with the drive cam 40, and can maintain the accommodation space 120 and the clutch space 620 in an airtight or liquid-tight manner.

Accordingly, for example, even if a foreign matter such as abrasion powder is generated in the clutch 70, the foreign matter can be restricted from entering the accommodation space 120 from the clutch space 620. Therefore, an operation failure of the motor 20 or the speed reducer 30 caused by the foreign matter can be reduced. Therefore, the operation failure of the clutch device 1 caused by the foreign matter can be reduced.

In the present embodiment, the inner sealing member 401 and the outer sealing member 402 as “seal members” are disposed to come into contact with the drive cam 40 as a “rotation portion” or the second ring gear 35 that rotates integrally with the drive cam 40, and the accommodation space 120 and the clutch space 620 are maintained in an airtight or liquid-tight manner. Therefore, the oil or the like containing the fine iron powder or the like can be restricted from entering the accommodation space 120 that accommodates the motor 20 and the speed reducer 30, and good performance of the clutch device 1 can be maintained for a long period of time.

In the present embodiment, the inner sealing member 401 and the outer sealing member 402 are provided to come into contact with the drive cam 40 that is a component decelerated by the speed reducer 30 and amplified to a large drive torque, or the second ring gear 35 that rotates integrally with the drive cam 40. Therefore, a ratio of a loss torque associated with the sealing performed by the “seal member” to the whole torque is reduced, which is advantageous in terms of efficiency. When the “seal member” comes in contact with the rotor 23 that is a component on an input side of the speed reducer 30, the loss torque due to the “seal member” is lost with respect to a small drive torque, and thus the efficiency may be significantly reduced.

In the present embodiment, in a flow path of power, an upstream side of the drive cam 40 is set as the accommodation space 120, and the accommodation space 120 is sealed by the inner sealing member 401 and the outer sealing member 402. In addition, the inner sealing member 401 and the outer sealing member 402 do not move relative to the housing 12 in the axial direction. Therefore, even if the drive cam 40 rotates, the capacity of the accommodation space 120 does not change. Accordingly, there is no influence of a change in a spatial capacity due to a translational motion of the driven cam 50 as a “translation portion”, and a special capacity change absorbing means such as a bellows seal member described in, for example, U.S. Pat. Application Publication No. 2015/0144453 is not necessary.

In the present embodiment, the inner sealing member 401 and the outer sealing member 402 as “seal members” are oil seals.

Therefore, a contact area between the inner sealing member 401 and the drive cam 40 or the second ring gear 35, and a contact area between the outer sealing member 402 and the drive cam 40 or the second ring gear 35 can be reduced. Accordingly, a sliding resistance acting on the inner sealing member 401 and the outer sealing member 402 during rotation of the drive cam 40 can be reduced. Therefore, a decrease in efficiency during the operation of the clutch device 1 can be reduced.

In the present embodiment, the state changing unit 80 includes the disk spring 81 as an “elastic deformation portion” that is elastically deformable in the axial direction of the driven cam 50 as a “translation portion”.

By controlling a rotation angular position of the motor 20, thrust control of the clutch 70 can be performed with high accuracy based on displacement and load characteristics of the disk spring 81. Therefore, the variation in the load acting on the clutch 70 with respect to the variation in the stroke of the driven cam 50 can be reduced. Accordingly, the load control can be performed with high accuracy, and the clutch device 1 can be controlled with high accuracy.

### Second Embodiment

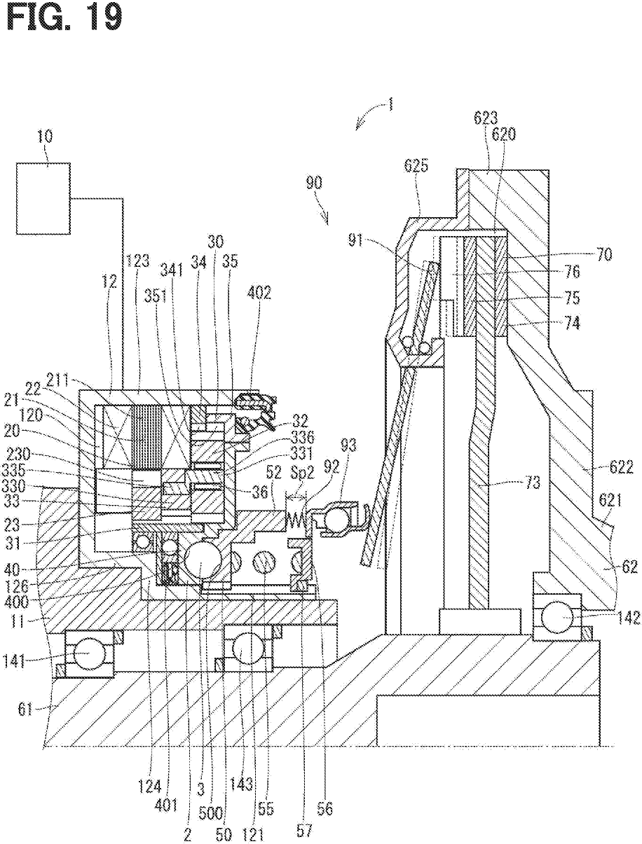

FIG. 19 shows a clutch device according to a second embodiment. The second embodiment is different from the first embodiment in configurations and the like of a clutch and a state changing unit.

In the present embodiment, ball bearings 141 and 143 are provided between the inner peripheral wall of the fixed body 11 and the outer peripheral wall of the input shaft 61. Accordingly, the input shaft 61 is bearing-supported by the fixed body 11 via the ball bearings 141 and 143.

The housing 12 is fixed to the fixed body 11 such that a part of an outer wall is in contact with a wall surface of the fixed body 11. For example, the housing 12 is fixed to the fixed body 11 such that a surface of the housing small plate portion 124 on a side opposite to the ball 3, the inner peripheral wall of the housing inner cylinder portion 121, and an inner peripheral wall of the housing small inner cylinder portion 126 is in contact with an outer wall of the fixed body 11. The housing 12 is fixed to the fixed body 11 by bolts (not shown) or the like. Here, the housing 12 is provided coaxially with the fixed body 11 and the input shaft 61.

An arrangement of the motor 20, the speed reducer 30, the ball cam 2, and the like with respect to the housing 12 is the same as that of the first embodiment.

In the present embodiment, the output shaft 62 includes the shaft portion 621, the plate portion 622, the cylinder portion 623, and a cover 625. The shaft portion 621 is formed in a substantially cylindrical shape. The plate portion 622 is formed integrally with the shaft portion 621 to extend in an annular plate shape from one end of the shaft portion 621 to the radially outer side. The cylinder portion 623 is formed integrally with the plate portion 622 to extend in a substantially cylindrical shape from an outer edge portion of the plate portion 622 to a side opposite to the shaft portion 621. The output shaft 62 is bearing-supported by the input shaft 61 via the ball bearing 142. The clutch space 620 is formed in the inside of the cylinder portion 623.

The clutch 70 is provided between the input shaft 61 and the output shaft 62 in the clutch space 620. The clutch 70 includes a support portion 73, a friction plate 74, a friction plate 75, and a pressure plate 76. The support portion 73 is formed in a substantially annular plate shape to extend from an outer peripheral wall of an end portion of the input shaft 61 to the radially outer side on a driven cam 50 side with respect to the plate portion 622 of the output shaft 62.

The friction plate 74 is formed in a substantially annular plate shape, and is provided on a plate portion 622 side of the output shaft 62 on an outer edge portion of the support portion 73. The friction plate 74 is fixed to the support portion 73. The friction plate 74 can come into contact with the plate portion 622 by deforming the outer edge portion of the support portion 73 toward the plate portion 622.

The friction plate 75 is formed in a substantially annular plate shape, and is provided on a side opposite to the plate portion 622 of the output shaft 62 on the outer edge portion of the support portion 73. The friction plate 75 is fixed to the support portion 73.

The pressure plate 76 is formed in a substantially annular plate shape, and is provided on the driven cam 50 side with respect to the friction plate 75.

In an engaged state in which the friction plate 74 and the plate portion 622 come into contact with each other, that is, are engaged with each other, a frictional force is generated between the friction plate 74 and the plate portion 622, and relative rotation between the friction plate 74 and the plate portion 622 is restricted according to a magnitude of the frictional force. On the other hand, in a non-engaged state in which the friction plate 74 and the plate portion 622 are separated from each other, that is, are not engaged with each other, no frictional force is generated between the friction plate 74 and the plate portion 622, and the relative rotation between the friction plate 74 and the plate portion 622 is not restricted.

When the clutch 70 is in the engaged state, the torque input to the input shaft 61 is transmitted to the output shaft 62 via the clutch 70. On the other hand, when the clutch 70 is in the non-engaged state, the torque input to the input shaft 61 is not transmitted to the output shaft 62.

The cover 625 is formed in a substantially annular shape, and is provided on the cylinder portion 623 of the output shaft 62 to cover the pressure plate 76 from a side opposite to the friction plate 75.

In the present embodiment, the clutch device 1 includes a state changing unit 90 instead of the state changing unit 80 shown in the first embodiment. The state changing unit 90 includes a diaphragm spring 91 as an “elastic deformation portion”, a return spring 92, a release bearing 93, and the like.

The diaphragm spring 91 is formed in a substantially annular disk spring shape, and is provided on the cover 625 such that one end in an axial direction, that is, an outer edge portion is in contact with the pressure plate 76. Here, the diaphragm spring 91 is formed such that the outer edge portion is located on a clutch 70 side with respect to an inner edge portion, and a portion between the inner edge portion and the outer edge portion is supported by the cover 625. The diaphragm spring 91 is elastically deformable in the axial direction. Accordingly, the diaphragm spring 91 urges the pressure plate 76 toward the friction plate 75 by the one end in the axial direction, that is, the outer edge portion. Accordingly, the pressure plate 76 is pressed against the friction plate 75, and the friction plate 74 is pressed against the plate portion 622. That is, the clutch 70 is normally in the engaged state.

In the present embodiment, the clutch device 1 is a so-called normally closed-type clutch device that is normally in the engaged state.

The return spring 92 is, for example, a coil spring, and is provided such that one end is in contact with an end surface of the driven cam cylinder portion 52 on the clutch 70 side.

The release bearing 93 is provided between the other end of the return spring 92 and the inner edge portion of the diaphragm spring 91. The return spring 92 urges the release bearing 93 toward the diaphragm spring 91. The release bearing 93 bearing-supports the diaphragm spring 91 while receiving a load in a thrust direction from the diaphragm spring 91. An urging force of the return spring 92 is smaller than an urging force of the diaphragm spring 91.

As shown in FIG. 19, when the ball 3 is located at one end of the drive cam groove 400 and the driven cam groove 500, a distance between the drive cam 40 and the driven cam 50 is relatively small, and a gap Sp2 is formed between the release bearing 93 and an end surface of the driven cam cylinder portion 52 of the driven cam 50. Therefore, the friction plate 74 is pressed against the plate portion 622 by the urging force of the diaphragm spring 91, the clutch 70 is in the engaged state, and torque transmission between the input shaft 61 and the output shaft 62 is permitted.

Here, when the electric power is supplied to the coil 22 of the motor 20 under the control of the ECU 10, the motor 20 rotates, the torque is output from the speed reducer 30, and the drive cam 40 rotates relative to the housing 12. Accordingly, the ball 3 rolls from the one end to the other end of the drive cam groove 400 and the driven cam groove 500. Therefore, the driven cam 50 moves relative to the housing 12 and the drive cam 40 in the axial direction, that is, moves toward the clutch 70. Accordingly, the gap Sp2 between the release bearing 93 and the end surface of the driven cam cylinder portion 52 is reduced, and the return spring 92 is compressed in the axial direction between the driven cam 50 and the release bearing 93.

When the driven cam 50 further moves toward the clutch 70, the return spring 92 is maximally compressed, and the release bearing 93 is pressed toward the clutch 70 by the driven cam 50. Accordingly, the release bearing 93 moves toward the clutch 70 against a reaction force from the diaphragm spring 91 while pressing the inner edge portion of the diaphragm spring 91.

When the release bearing 93 moves toward the clutch 70 while pressing the inner edge portion of the diaphragm spring 91, the inner edge portion of the diaphragm spring 91 moves toward the clutch 70, and the outer edge portion of the diaphragm spring 91 moves toward a side opposite to the clutch 70. Accordingly, the friction plate 74 is separated from the plate portion 622, and a state of the clutch 70 is changed from the engaged state to the non-engaged state. As a result, the torque transmission between the input shaft 61 and the output shaft 62 is blocked.

When a clutch transmission torque is 0, the ECU 10 stops the rotation of the motor 20. Accordingly, the state of the clutch 70 is maintained in the non-engaged state. In this way, the diaphragm spring 91 of the state changing unit 90 can receive a force in the axial direction from the driven cam 50 and change the state of the clutch 70 to the engaged state or the non-engaged state according to a relative position of the driven cam 50 in the axial direction with respect to the housing 12.

In the present embodiment, the inner sealing member 401 and the outer sealing member 402 as “seal members” also can maintain the accommodation space 120 and the clutch space 620 in an airtight or liquid-tight manner.

In the present embodiment, the clutch device 1 does not include the oil supply portion 5 shown in the first embodiment. That is, in the present embodiment, the clutch 70 is a dry clutch.

In this way, the present disclosure is also applicable to a normally closed-type clutch device including a dry clutch.

As described above, in the present embodiment, the state changing unit 90 includes the diaphragm spring 91 as an “elastic deformation portion” that is elastically deformable in the axial direction of the driven cam 50 as a “translation portion”.

By controlling the rotation angular position of the motor 20, thrust control of the clutch 70 can be performed with high accuracy based on displacement and load characteristics of the diaphragm spring 91. Therefore, the variation in the load acting on the clutch 70 with respect to the variation in the stroke of the driven cam 50 can be reduced. Accordingly, as in the first embodiment, load control can be performed with high accuracy, and the clutch device 1 can be controlled with high accuracy.

### Third Embodiment

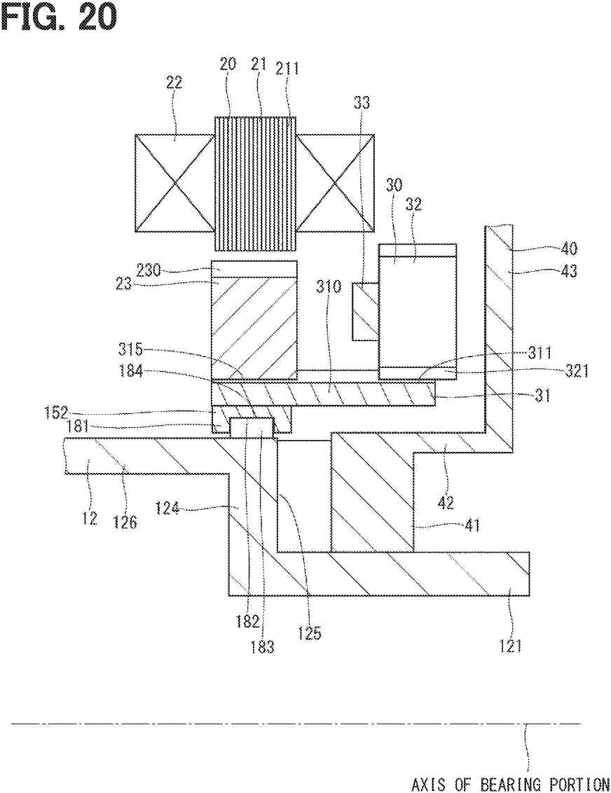

FIG. 20 shows a part of a clutch device according to a third embodiment. The third embodiment is different from the first embodiment in a configuration of a bearing portion and the like.

In the present embodiment, a bearing portion 152 is provided instead of the bearing portion 151 shown in the first embodiment. The bearing portion 152 includes multiple bearing rolling bodies 183 that roll in a circumferential direction of the rotor 23 and rotatably support the rotor 23, and a lubricant 184 that lubricates a periphery of the bearing rolling bodies 183. The bearing portion 152 rotatably supports the rotor 23 via the sun gear 31. Here, only one bearing portion 152 that rotatably supports the rotor 23 is provided.

More specifically, the bearing portion 152 includes a support 181, a support recess portion 182, the bearing rolling bodies 183, and the lubricant 184.

The support 181 is formed of, for example, metal in a substantially cylindrical shape. The support recess portion 182 is formed to be recessed from an inner peripheral wall of the support 181 to the radially outer side.

The bearing rolling body 183 is, for example, a “roller” formed of, for example, metal in a substantially columnar shape. The bearing rolling body 183 is provided in the support recess portion 182 such that an axis is substantially parallel to an axis of the support 181. The bearing rolling body 183 is rotatable about an axis within the support recess portion 182. In the present embodiment, for example, eight bearing rolling bodies 183 are provided at equal intervals in a circumferential direction of the support 181.

The bearing portion 152 is provided such that an outer peripheral wall of the support 181 is fitted to one end portion of the sun gear main body 310, that is, an inner peripheral wall of an end portion on a side opposite to the sun gear tooth portion 311, and the bearing rolling body 183 is to come into contact with an outer peripheral wall of the housing inner cylinder portion 121. Accordingly, the rotor 23 is rotatably supported by the housing inner cylinder portion 121 via the sun gear 31 and the bearing portion 152. That is, the bearing portion 152 rotatably supports the rotor 23.

Here, when the rotor 23 rotates relative to the housing inner cylinder portion 121, the bearing rolling body 183 rotates in the support recess portion 182.

The lubricant 184 is, for example, a fluid such as grease. The lubricant 184 is provided in the periphery of the bearing rolling bodies 183 and in the support recess portion 182 of the support 181 to lubricate the periphery of the bearing rolling bodies 183. Accordingly, the bearing rolling body 183 can smoothly roll between the support 181 and the housing 12 in the support recess portion 182.

A kinematic viscosity of the lubricant 184 varies depending on an environmental temperature. The lubricant 184 has a higher kinematic viscosity as the environmental temperature is lower, for example.

An outer diameter of the bearing portion 152, that is, an outer diameter of the support 181 is smaller than the outer diameter of the bearing portion 151, that is, the outer diameter of the outer ring 172 shown in the first embodiment.

The bearing portion 152 is a “roller bearing” including the bearing rolling body 183 as a “roller”. More specifically, the bearing portion 152 is a “single-row roller bearing” in which the bearing rolling bodies 183 are arranged in one row in an axial direction of the support 181 (see FIG. 20).

Therefore, as compared with the bearing portion 151 as a “ball bearing” shown in the first embodiment, a size and a cost of the bearing portion 152 can be reduced.

### Fourth Embodiment

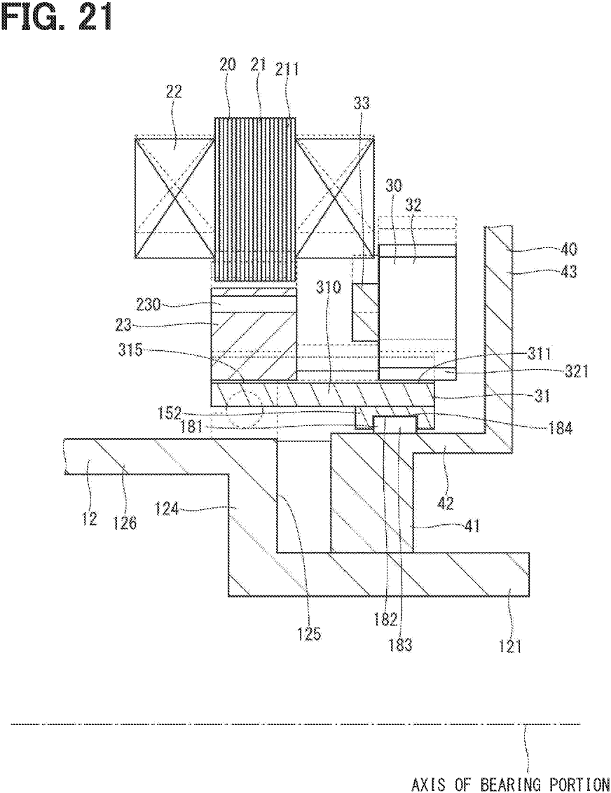

FIG. 21 shows a part of a clutch device according to a fourth embodiment. The fourth embodiment is different from the first embodiment in a configuration of a bearing portion and the like.

In the present embodiment, a bearing portion 152 is provided instead of the bearing portion 151 shown in the first embodiment. Since the configuration of the bearing portion 152 is the same as that of the bearing portion 152 described in the third embodiment, the description thereof will be omitted.

The bearing portion 152 is provided such that an outer peripheral wall of the support 181 is fitted to the other end portion of the sun gear main body 310, that is, an inner peripheral wall of an end portion on a sun gear tooth portion 311 side, and the bearing rolling body 183 is to come into contact with an outer peripheral wall of the drive cam main body 41. Accordingly, the rotor 23 is rotatably supported by the drive cam main body 41 via the sun gear 31 and the bearing portion 152. That is, the bearing portion 152 rotatably supports the rotor 23.

In this way, in the present embodiment, only one bearing portion 152 rotatably supporting the rotor 23 is provided.

An outer diameter of the bearing portion 152 is smaller than the outer diameter of the bearing portion 151, that is, the outer diameter of the outer ring 172 shown in the first embodiment.

The magnet 230 is provided not on the outer peripheral wall of the rotor 23 but on an inside of the outer peripheral wall of the rotor 23. That is, the motor 20 is an interior permanent magnet (IPM) motor.

An outer diameter of the stator core 211 is the same as an outer diameter of the stator core 211 in the first embodiment. In addition, a length of the stator core 211 in the radial direction is larger than a length of the stator core 211 in the radial direction in the first embodiment. Therefore, as compared with the first embodiment, the number of turns of a winding of the coil 22 can be increased.

In the present embodiment, a radial space of the motor 20 is ensured by providing the bearing portion 152 having a small size in the radial direction on the radially inner side of the sun gear tooth portion 311 as an “input unit”, and as compared with the first embodiment, an outer diameter of the rotor 23 is reduced, the length of the stator core 211 in the radial direction is increased, and the number of turns of the winding of the coil 22 is increased. Accordingly, a torque constant can be increased, and a motor having a high output and a high torque can be implemented.

Since the motor 20 is an interior permanent magnet (IPM) motor, a machining cost of the magnet (permanent magnet) can be reduced, and a cost of the entire clutch device 1 can be reduced.

As described above, the bearing portion 152 is provided on the radially inner side of the sun gear tooth portion 311 as an “input unit”, and rotatably supports the rotor 23. More specifically, the bearing portion 152 rotatably supports the rotor 23 via the sun gear 31 provided integrally with the rotor 23.

In the present embodiment, by providing the bearing portion 152 having a small size in the radial direction on the radially inner side of the sun gear tooth portion 311, the radial space of the motor 20 can be ensured as compared with the first embodiment in which the bearing portion 151 is provided on the radially inner side of the rotor 23. Accordingly, a degree of freedom in design of the motor 20 can be improved.

### Fifth Embodiment

FIG. 22 shows a part of a clutch device according to a fifth embodiment. The fifth embodiment is different from the first embodiment in a configuration of a seal member and the like.

In the present embodiment, an outer sealing member 403 is provided instead of the outer sealing member 402 shown in the first embodiment. The outer sealing member 403 is formed of, for example, an elastic material such as rubber in an annular shape. The outer sealing member 403 a so-called O-ring.

The outer sealing member 403 is provided in an annular seal groove portion 358 formed in an outer peripheral wall of the gear outer cylinder portion 357. That is, the outer sealing member 403 is provided to come into contact with the second ring gear 35 that rotates integrally with the drive cam 40 on the radially outer side of the drive cam 40 as a “rotation portion”.

An inner peripheral wall of the housing outer cylinder portion 123 is slidable on an outer edge portion of the outer sealing member 403. That is, the outer sealing member 403 is provided to come into contact with the housing outer cylinder portion 123 of the housing 12. The outer sealing member 403 is elastically deformed in the radial direction, and seals between the gear outer cylinder portion 357 and the inner peripheral wall of the housing outer cylinder portion 123 in an airtight or liquid-tight manner.

As described above, in the present embodiment, the outer sealing member 403 as a “seal member” is an O-ring.

Therefore, the configuration of the clutch device 1 can be simplified and the cost thereof can be reduced.

### Sixth Embodiment

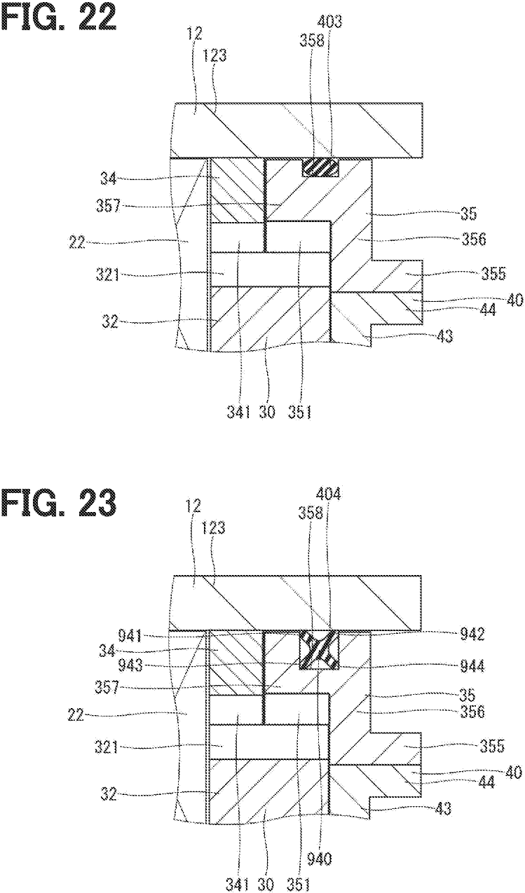

FIG. 23 shows a part of a clutch device according to a sixth embodiment. The sixth embodiment is different from the fifth embodiment in a configuration of a seal member and the like.

In the present embodiment, an outer sealing member 404 is provided instead of the outer sealing member 403 shown in the fifth embodiment. The outer sealing member 404 is formed of, for example, an elastic material such as rubber in an annular shape.

More specifically, the outer sealing member 404 includes a seal annular portion 940, a first outer lip portion 941, a second outer lip portion 942, a first inner lip portion 943, and a second inner lip portion 944. The seal annular portion 940, the first outer lip portion 941, the second outer lip portion 942, the first inner lip portion 943, and the second inner lip portion 944 are integrally formed.

The seal annular portion 940 is formed in a substantially annular shape. The first outer lip portion 941 is formed in an annular shape over an entire range in the circumferential direction of the seal annular portion 940 to extend from the seal annular portion 940 and incline toward the radially outer side and one side in the axial direction. The second outer lip portion 942 is formed in an annular shape over the entire range in the circumferential direction of the seal annular portion 940 to extend from the seal annular portion 940 and incline toward the radially outer side and the other side in the axial direction. The first inner lip portion 943 is formed in an annular shape over the entire range in the circumferential direction of the seal annular portion 940 to extend from the seal annular portion 940 and incline toward the radially inner side and the one side in the axial direction. The second inner lip portion 944 is formed in an annular shape over the entire range in the circumferential direction of the seal annular portion 940 to extend from the seal annular portion 940 and incline toward the radially inner side and the other side in the axial direction. Accordingly, the outer sealing member 404 is formed to have an X-shape in a cross section taken along a virtual plane including all the axes (see FIG. 23).

As shown in FIG. 23, the outer sealing member 404 is provided in the annular seal groove portion 358 formed in an outer peripheral wall of the gear outer cylinder portion 357. Here, tip portions of the first inner lip portion 943 and the second inner lip portion 944 come into contact with the seal groove portion 358. That is, the outer sealing member 404 is provided to come into contact with the second ring gear 35 that rotates integrally with the drive cam 40 on the radially outer side of the drive cam 40 as a “rotation portion”.

The tip portions of the first outer lip portion 941 and the second outer lip portion 942 come into contact with an inner peripheral wall of the housing outer cylinder portion 123. Therefore, a contact area between the outer sealing member 404 and the housing outer cylinder portion 123 is smaller than a contact area between the outer sealing member 403 and the housing outer cylinder portion 123 in the fifth embodiment. Accordingly, a sliding resistance acting on the outer sealing member 404 during rotation of the drive cam 40 can be reduced.

The first outer lip portion 941 and the second outer lip portion 942 of the outer sealing member 404 are elastically deformed in the radial direction and seal between the gear outer cylinder portion 357 and the inner peripheral wall of the housing outer cylinder portion 123 in an airtight or liquid-tight manner. The outer sealing member 404 is a so-called lip seal.

As described above, in the present embodiment, the outer sealing member 404 as a “seal member” is a lip seal.

Therefore, the contact area between the outer sealing member 404 and the housing outer cylinder portion 123 can be reduced. Accordingly, the sliding resistance acting on the outer sealing member 404 during the rotation of the drive cam 40 can be reduced. Therefore, a decrease in efficiency during the operation of the clutch device 1 can be reduced.

### Other Embodiments

In the above embodiments, an example is shown in which the number of bearing rolling bodies of the bearing portion is set to a smallest possible number within a range in which the load applied to the bearing portion can be withstood and a range in which the assembly condition of the bearing portion is satisfied. On the other hand, in other embodiments, the number of bearing rolling bodies may be any number as long as the number of bearing rolling bodies is within the range in which the load applied to the bearing portion can be withstood and the range in which the assembly condition of the bearing portion is satisfied.

In the above first embodiment, an example is shown in which the number of bearing rolling bodies is smaller than the number of holding hole portions. On the other hand, in other embodiments, the number of bearing rolling bodies may be the same as the number of holding hole portions.

In the above first embodiment, an example is shown in which the bearing portion is a “single-row ball bearing”. On the other hand, in other embodiments, the bearing portion may be a “multi-row ball bearing” in which multiple rows of bearing rolling bodies as “balls” are arranged in the axial direction of the inner ring and the outer ring.

In the above third embodiment, an example is shown in which the bearing portion is a “single-row roller bearing”. On the other hand, in other embodiments, the bearing portion may be a “multi-row roller bearing” in which multiple rows of bearing rolling bodies as “rollers” are arranged in the axial direction of the support.

In the above fourth embodiment, an example is shown in which the bearing portion is provided on the radially inner side of the input unit of the speed reducer. On the other hand, in other embodiments, the bearing portion may be provided on the radially outer side of the input unit and rotatably support the rotor.

In other embodiments, the motor 20 may not include the magnet 230 as a “permanent magnet”.

In the above embodiments, an example is shown in which the drive cam 40 as a “rotation portion” is formed separately from the second ring gear 35 of the speed reducer 30. On the other hand, in other embodiments, the drive cam 40 as a “rotation portion” may be formed integrally with the second ring gear 35 of the speed reducer 30. In this case, the number of members and the number of assembling steps can be reduced, and further cost reduction can be achieved.

In other embodiments, the drive cam 40 as a “rotation portion” may be formed such that the inner edge portion and the outer edge portion are located at the same position in the axial direction.

In other embodiments, the inner sealing member 401 as a “seal member” is not limited to the oil seal, and may be an O-ring or a lip seal.

Further, in other embodiments, the “seal member” that maintains the accommodation space and the clutch space in an airtight or liquid-tight manner may not be provided.

In the above embodiments, the inner rotor type motor 20 in which the rotor 23 is provided on the radially inner side of the stator 21 is shown. On the other hand, in other embodiments, the motor 20 may be an outer rotor-type motor in which the rotor 23 is provided on the radially outer side of the stator 21.

In the above embodiments, an example is shown in which the rotational translation unit is a rolling body cam including a drive cam, a driven cam, and a rolling body. On the other hand, in other embodiments, the rotational translation unit may include, for example, a “slide screw” or a “ball screw” as long as the rotational translation unit includes a rotation portion that rotates relative to the housing and a translation portion that moves relative to the housing in the axial direction when the rotation portion rotates relative to the housing.

In other embodiments, the elastic deformation portion of the state changing unit may be, for example, a coil spring or rubber as long as the elastic deformation portion is elastically deformable in the axial direction. In addition, in other embodiments, the state changing unit may include only a rigid body without including the elastic deformation portion.

In other embodiments, the number of drive cam grooves 400 and the number of driven cam grooves 500 are not limited to five and may be any number as long as the number of drive cam grooves 400 and the number of driven cam grooves 500 is three or more. In addition, the number of balls 3 may be adjusted according to the number of drive cam grooves 400 and driven cam grooves 500.

The present disclosure can be applied not only to the vehicle that travels by the drive torque from the internal combustion engine, but also to an electric vehicle, a hybrid vehicle, or the like that can travel by a drive torque from a motor.

In other embodiments, the torque may be input from the second transmission portion, and output from the first transmission portion via the clutch. In addition, for example, when one of the first transmission portion and the second transmission portion is non-rotatably fixed, the rotation of the other of the first transmission portion and the second transmission portion can be stopped by making the clutch to the engaged state. In this case, the clutch device can be used as a brake device.

As described above, the present disclosure is not limited to the above embodiments, and can be implemented in various forms within a scope not departing from the concept of the present disclosure.

The control unit of the clutch device and the method thereof described in the present disclosure may be implemented by a dedicated computer that is provided by configuring a processor and a memory programmed to execute one or more functions embodied by a computer program. Alternatively, the control unit of the clutch device and the method thereof described in the present disclosure may be implemented by a dedicated computer provided by configuring a processor with one or more dedicated hardware logic circuits. Alternatively, the control unit of the clutch device and the method thereof described in the present disclosure may be implemented by one or more dedicated computers configured by a combination of a processor and a memory programmed to execute one or multiple functions and a processor configured by one or more hardware logic circuits. In addition, the computer program may be stored in a computer-readable non-transitional tangible recording medium as an instruction executed by a computer.

The present disclosure has been described based on the embodiments. However, the present disclosure is not limited to the embodiments and the structures. The present disclosure also includes various modification examples and modifications within the scope of equivalents. In addition, various combinations and forms, and further, other combinations and forms which include only one element, more elements, or less elements are included in the scope and the spirit of the present disclosure.

What is claimed is:

1. A clutch device comprising:
a housing;
a prime mover including a stator, which is provided in the housing, and a rotor, which is configured to rotate relative to the stator, the prime mover configured to operate by energization and output a torque from the rotor;
a speed reducer configured to decelerate and output the torque of the prime mover;
a rotational translation unit including a rotation portion, which is configured to rotate relative to the housing when the torque output from the speed reducer is input, and a translation portion, which is movable relative to the housing in an axial direction when the rotation portion rotates relative to the housing;
a clutch provided between a first transmission portion and a second transmission portion, which are configured to rotate relative to the housing, the clutch configured to permit torque transmission between the first transmission portion and the second transmission portion when in an engaged state and block the torque transmission between the first transmission portion and the second transmission portion when in a non-engaged state;
a state changing unit configured to receive a force in the axial direction from the translation portion and change a state of the clutch to the engaged state or the non-engaged state according to a relative position of the translation portion with respect to the housing in the axial direction; and
a bearing portion including a plurality of bearing rolling bodies, which are configured to roll in a circumferential direction of the rotor and rotatably support the rotor, and a lubricant, which is configured to lubricate a periphery of the bearing rolling bodies, wherein
the speed reducer includes an input unit configured to rotate integrally and coaxially with the rotor and receive the torque from the rotor,
the input unit is in a tubular shape, and
an outer peripheral wall and an inner peripheral wall of the input unit are coaxial with each other.

2. The clutch device according to claim 1, wherein
the bearing portion is configured to rotatably support the rotor and the input unit, and
a number of the bearing portion is one in an axial direction of the rotor and the input unit.

3. The clutch device according to claim 1, wherein
a number of bearing rolling bodies is set as small as possible within a range in which a load applied to the bearing portion is withstood and within a range in which an assembly condition of the bearing portion is satisfied.

4. The clutch device according to claim 1, wherein
the bearing portion includes a retainer in which a plurality of holding hole portions configured to hold the bearing rolling bodies are formed, and
a number of bearing rolling bodies is smaller than a number of holding hole portions.

5. The clutch device according to claim 1, wherein
the bearing portion is a ball bearing or a roller bearing.

6. The clutch device according to claim 1, wherein
the bearing portion is provided away from the input unit in an axial direction of the bearing portion.

7. The clutch device according to claim 1, wherein
the bearing portion is provided on a radially inner side or a radially outer side of the input unit and is configured to rotatably support the rotor.

8. The clutch device according to claim 1, wherein
the prime mover includes a permanent magnet provided on the rotor.

9. The clutch device according to claim 1, wherein
the speed reducer includes:
a planetary gear configured to revolve in a circumferential direction of the input unit while meshing with the input unit and rotating on its axis;
a carrier configured to rotatably support the planetary gear and rotatable relative to the input unit;
a first ring gear configured to mesh with the planetary gear; and
a second ring gear configured to mesh with the planetary gear, formed such that a number of teeth of a tooth portion is different from that of the first ring gear, and configured to output a torque to the rotation portion.

10. The clutch device according to claim 9, wherein
the first ring gear is fixed to the housing, and
the second ring gear is configured to rotate integrally with the rotation portion.

11. The clutch device according to claim 9, wherein the rotation portion is formed integrally with the second ring gear.

12. The clutch device according to claim 1, wherein
the rotation portion is a drive cam including a plurality of drive cam grooves formed on one surface,
the translation portion is a driven cam including a plurality of driven cam grooves formed on one surface, and
the rotational translation unit is a rolling body cam including the drive cam, the driven cam, and a rolling body configured to roll between the drive cam grooves and the driven cam grooves.

13. The clutch device according to claim 1, wherein
the rotation portion is formed such that an inner edge portion and an outer edge portion are located at different positions in the axial direction.

14. The clutch device according to claim 1, wherein
the prime mover and the speed reducer are provided in an accommodation space formed inside the housing on a side opposite to the clutch with respect to the rotation portion,
the clutch is provided in a clutch space, which is a space on a side opposite to the accommodation space with respect to the rotation portion, and
the clutch device further includes an annular seal member configured to come into contact with the rotation portion or a member, which is configured to rotate integrally with the rotation portion, and maintain the accommodation space and the clutch space in an airtight or liquid-tight manner.

15. The clutch device according to claim 14, wherein
the seal member is any one of an O-ring, a lip seal, and an oil seal.

16. The clutch device according to claim 1, wherein
the state changing unit includes an elastic deformation portion elastically deformable in the axial direction of the translation portion.
